(19) United States
(12) Patent Application Publication
(10) Pub. No.: US 2026/0252917 A1
(43) Pub. Date: Aug. 27, 2026

(54) SYSTEM

(71) Applicant: SoftBank Group Corp., Tokyo (JP)

(72) Inventor: Tetsuya TAKATORI, Tokyo (JP)

(73) Assignee: SoftBank Group Corp., Tokyo (JP)

(21) Appl. No.: 19/542,676

(22) Filed: Feb. 18, 2026

(30) Foreign Application Priority Data
Feb. 21, 2025 (JP) 2025-026983

(51) Int. Cl. G06N 5/04

(52) U.S. Cl. CPC G06N 5/04

(57) ABSTRACT

The system according to the embodiment comprises an analysis unit, a specifying unit, a prioritization unit, and a display unit. The analysis unit analyzes a customer's past contract history. The specifying unit identifies uncontracted products based on data analyzed by the analysis unit. The prioritization unit assigns proposal priorities to the uncontracted products identified by the specifying unit. The display unit displays proposal points for the products prioritized by the prioritization unit.

### CROSS-REFERENCE TO RELATED APPLICATION

The present application claims priority to and incorporates by reference the entire contents of Japanese Patent Application No. 2025-026983 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, proposals for products based on a customer's past contract history have not been sufficiently made, resulting in issues such as missed proposals and challenges in improving acquisition rates.

### SUMMARY OF THE INVENTION

The system according to the embodiment comprises an analysis unit, a specifying unit, a prioritization unit, and a display unit. The analysis unit analyzes a customer's past contract history. The specifying unit identifies uncontracted products based on data analyzed by the analysis unit. The prioritization unit assigns proposal priorities to the uncontracted products identified by the specifying unit. The display unit displays proposal points for the products prioritized by the prioritization unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

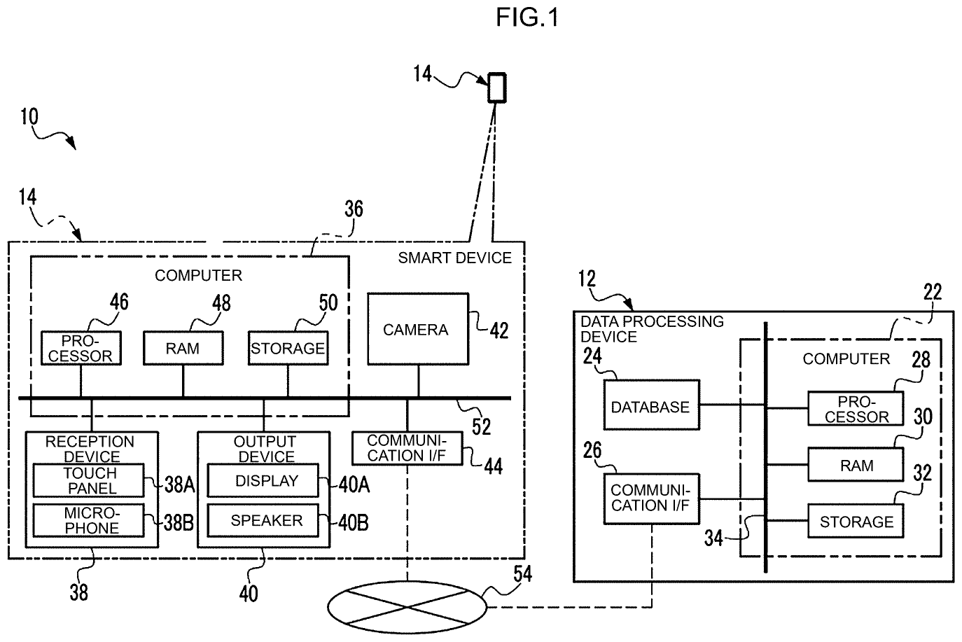

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

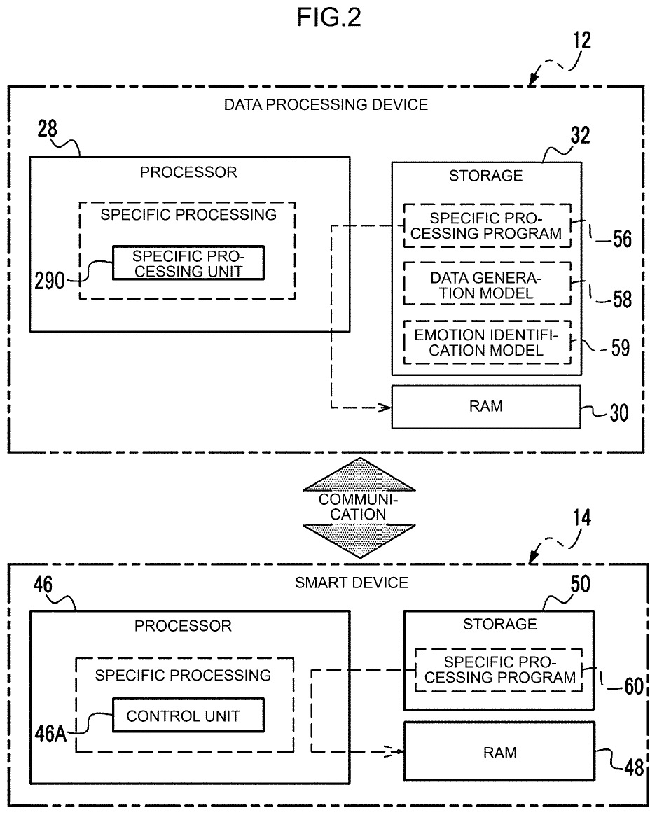

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system equipped with generative AI in systems deployed at SoftBank sales agencies, which performs proposal prioritization during customer searches, displays uncontracted products, and displays proposal points based on past contract history. When a customer is searched, the generative AI analyzes the customer's past contract history and identifies uncontracted products. Next, the generative AI assigns proposal priorities to the uncontracted products and makes optimal proposals to the customer. At this time, the generative AI displays proposal points based on the past contract history to prevent omission of product proposals. Furthermore, by assigning proposal priorities, the generative AI can improve the acquisition rate of products. For example, when a customer is searched, the generative AI analyzes the customer's past contract history. For instance, it collects data such as products previously contracted by the customer, contract periods, and contract details, and by analyzing these, the generative AI can grasp the customer's needs and interests. This enables the identification of uncontracted products. Next, the generative AI assigns proposal priorities to the uncontracted products. For example, based on the customer's needs and interests, the most suitable products can be proposed with priority. This allows for optimal proposals to the customer. Furthermore, the generative AI displays proposal points based on the past contract history. For example, when proposing products related to those previously contracted by the customer, displaying points indicating such relevance enables more persuasive proposals to the customer. This mechanism prevents omission of product proposals and improves the acquisition rate of products. By assigning proposal priorities, the generative AI can make optimal proposals to the customer and improve the acquisition rate of products. Additionally, it contributes to the simplification of strategy meetings, reduction of customer service time, and maintenance of proposal quality in the absence of strategy advisors. For example, by assigning proposal priorities, discussions in strategy meetings are simplified and can proceed efficiently. Also, by displaying proposal points, customer service time is shortened, allowing for quick proposals to customers. Furthermore, even in the absence of a strategy advisor, proposal quality can be maintained by assigning proposal priorities with generative AI. Thus, the system can prevent omission of product proposals and improve acquisition rates. Specifically, the system operates on a server group equipped with large language models and multimodal generative models, accepting customer identification information such as customer ID and name as input during customer searches. The system obtains the customer's past contract history data (e.g., records in a structured database including product ID, contract start date, contract end date, contract amount, contract options, cancellation reasons, etc.), vectorizes and tensorizes these, and inputs them into the AI model. For example, the input tensor may contain up to 100 contract history records per customer, each represented as a 10-dimensional feature vector (product category, contract period, amount, usage frequency, cancellation status, etc.). The AI model uses a Transformer-based architecture and extracts relationships between histories in a high-dimensional space via self-attention mechanisms. The AI model inputs a list of uncontracted product candidates (e.g., excluding already contracted products from the full product list) and outputs a “proposal priority score” (continuous value from 0.0 to 1.0) for each candidate. For example, output examples such as “Product A: 0.92, Product B: 0.75, Product C: 0.31” can be obtained. Furthermore, for each product, the AI model generates natural language text as “proposal points,” such as explanations of relevance to past contract history (e.g., “Improved convenience when combined with previously contracted Product X”), reasons for recommendation, price advantages, etc. These outputs are filtered by a subsequent threshold judgment module according to rules such as “display only those with priority above 0.8,” and sent to the display unit. The display unit lists product names, proposal points, and priority scores on the GUI, which can be used by operators as supporting information when making proposals to customers. As a technical effect, this system, unlike conventional manual history reference and proposal work, combines high-dimensional feature extraction by AI and rule-based prioritization, enabling significant improvement in comprehensiveness and accuracy of proposals. This realizes essential improvements in computer technology, such as prevention of proposal omissions, increased product acquisition rates, reduced operator workload, streamlined strategy meetings, and elimination of subjective judgments. Application fields include a wide range of proposal operations based on customer history, such as telecommunications service sales, insurance product proposals, financial product cross-selling, e-commerce site recommendation engines, and B2B sales support.

The system according to the embodiment comprises an analysis unit, a specifying unit, a prioritization unit, and a display unit. The analysis unit analyzes the customer's past contract history. The customer's past contract history may include, for example, contract type, contract period, contract amount, but is not limited to such examples. The analysis unit collects customer contract history data and analyzes it using AI, for example. For instance, the analysis unit collects data such as products previously contracted by the customer, contract periods, and contract details, and by analyzing these with AI, can grasp the customer's needs and interests. The specifying unit identifies uncontracted products based on data analyzed by the analysis unit. Uncontracted products may include, for example, products in specific categories or products not contracted within a certain period, but are not limited to such examples. The specifying unit identifies uncontracted products using AI based on data analyzed by the analysis unit, for example. For instance, the specifying unit identifies uncontracted products based on the customer's needs and interests. The prioritization unit assigns proposal priorities to the uncontracted products identified by the specifying unit. Proposal priorities may include, for example, customer needs, product importance, but are not limited to such examples. The prioritization unit assigns proposal priorities to the uncontracted products identified by the specifying unit using AI, for example. For instance, the prioritization unit preferentially proposes the most suitable products based on the customer's needs and interests. The display unit displays proposal points for the products prioritized by the prioritization unit. Proposal points may include, for example, key points of the proposal, advantages, price, but are not limited to such examples. The display unit displays proposal points for the products prioritized by the prioritization unit, for example. For instance, when proposing products related to those previously contracted by the customer, the display unit displays points indicating such relevance. Thus, the system according to the embodiment can prevent omission of product proposals and improve acquisition rates. For example, by analyzing the customer's contract history, identifying uncontracted products, assigning proposal priorities, and displaying proposal points, the system can prevent omission of product proposals and improve acquisition rates. Specifically, the system operates on a server group equipped with large language models and multimodal generative models as the analysis unit, accepting customer identification information such as customer ID and name as input during customer searches. The analysis unit obtains the customer's past contract history data (e.g., records in a structured database including product ID, contract start date, contract end date, contract amount, contract options, cancellation reasons, etc.), vectorizes and tensorizes these, and inputs them into the AI model. For example, the input tensor may contain up to 100 contract history records per customer, each represented as a 10-dimensional feature vector (product category, contract period, amount, usage frequency, cancellation status, etc.). The analysis unit uses a Transformer-based architecture and extracts relationships between histories in a high-dimensional space via self-attention mechanisms. The specifying unit inputs a list of uncontracted product candidates (e.g., excluding already contracted products from the full product list) and outputs a “proposal priority score” (continuous value from 0.0 to 1.0) for each candidate. For example, output examples such as “Product A: 0.92, Product B: 0.75, Product C: 0.31” can be obtained. The prioritization unit performs threshold judgment and ranking based on these scores to determine the final proposal order. Furthermore, for each product, the AI model generates natural language text as “proposal points,” such as explanations of relevance to past contract history (e.g., “Improved convenience when combined with previously contracted Product X”), reasons for recommendation, price advantages, etc. The display unit lists product names, proposal points, and priority scores on the GUI, which can be used by operators as supporting information when making proposals to customers. Examples of AI input include customer ID “12345,” contract history tensor (e.g., [[1,20210101,20220101,10000,1,0,0,0,0,0], . . . ]), and uncontracted product ID list [5,7,9]. Examples of AI output include product ID 5: 0.92, product ID 7: 0.75, product ID 9: 0.31, proposal point “Product 5 improves convenience when combined with previously contracted Product 1,” etc. Subsequent processing includes threshold judgment to display only those with priority above 0.8, notification to operators, and recording in the history database. As a technical effect, this system, unlike conventional manual history reference and proposal work, combines high-dimensional feature extraction by AI and rule-based prioritization, enabling significant improvement in comprehensiveness and accuracy of proposals. This realizes essential improvements in computer technology, such as prevention of proposal omissions, increased product acquisition rates, reduced operator workload, streamlined strategy meetings, and elimination of subjective judgments. Application fields include a wide range of proposal operations based on customer history, such as telecommunications service sales, insurance product proposals, financial product cross-selling, e-commerce site recommendation engines, and B2B sales support.

The analysis unit can estimate the customer's emotions and adjust the method of analyzing the contract history based on the estimated emotions of the customer. For example, if the customer is feeling stressed, the analysis unit selects a simple analysis method and quickly produces results. If the customer is relaxed, the analysis unit selects a detailed analysis method and considers more data. Additionally, if the customer is excited, the analysis unit provides visually easy-to-understand analysis results. By adjusting the analysis method according to the customer's emotions, more appropriate analysis results can be provided. Emotion estimation is realized using an emotion engine or generative AI, for example, by employing emotion estimation functions. Generative AI may be, for example, text-generating AI (such as LLM) or multimodal generative AI, but is not limited to such examples. Some or all of the above-described processing in the analysis unit may be performed using AI or without using AI. For example, the analysis unit may input customer emotion data into generative AI and have the generative AI perform emotion estimation. Specifically, the analysis unit accepts multimodal data as input for customer emotion estimation, such as voice data (e.g., conversation audio waveform data, sampling rate 16 kHz, one minute of audio), text data (e.g., chat history, about 1000 tokens), and facial images (e.g., face images 128×128 pixels). The analysis unit performs preprocessing on these data (e.g., voice feature extraction, facial landmark detection, morphological analysis of text) and inputs them into a multimodal neural network for emotion estimation (e.g., CNN+RNN for voice, CNN for images, Transformer for text). The AI model outputs a probability distribution for each emotion category (e.g., stress, relaxation, excitement, sadness, joy). The analysis unit selects the emotion category with the highest probability and transmits it to the analysis method selection module. For example, if stress is high, a simple analysis using only major features of the contract history (e.g., contract amount, contract period, cancellation status) is selected; if relaxed, a detailed analysis using all features (e.g., contract options, usage frequency, related products) is selected; if excited, a display mode that visualizes analysis results as graphs or charts is selected. Examples of AI input include audio waveform data, chat text such as “I am satisfied with my recent contract,” and facial image data. Examples of AI output include emotion category “stress” probability 0.8, “relaxation” probability 0.1, “excitement” probability 0.1, etc. Subsequent processing includes branching of analysis algorithms and switching of analysis result display methods according to the emotion category. As a technical effect, the analysis unit dynamically optimizes the analysis method according to the customer's emotional state, achieving both improved customer experience and analysis accuracy. It can flexibly respond to diverse customer states that could not be addressed by conventional uniform analysis methods, improving the persuasiveness and utility of analysis results. Application fields include call center support, online customer service, medical consultations, personalized learning support in education, and other scenes where information analysis according to emotional state is required.

The analysis unit can analyze not only the customer's past contract history but also the customer's purchase history and website browsing history. For example, the analysis unit collects the customer's past purchase history and analyzes it in combination with the contract history. For instance, the analysis unit collects the customer's website visit history and analyzes it in relation to the contract history. Additionally, the analysis unit can analyze the customer's online shopping history and compare it with the contract history. By analyzing the customer's purchase history and website browsing history, more detailed customer needs can be identified. Some or all of the above-described processing in the analysis unit may be performed using AI or without using AI. For example, the analysis unit may input the customer's purchase history data into generative AI and have the generative AI perform purchase history analysis. Specifically, the analysis unit collects the customer's purchase history data (e.g., records in a structured database including product ID, purchase date, purchase amount, category, quantity, payment method, etc.) and website browsing history (e.g., URL, access date and time, page category, time spent, etc.). The analysis unit vectorizes these data, inputs purchase history as a time-series tensor (e.g., up to 200 records, each with 10 dimensions) and browsing history as a sequence data arranged in access order (e.g., up to 500 records, each with 5 dimensions) into the AI model. The AI model uses Transformer or time-series RNN to extract patterns of purchase and browsing behavior and analyzes correlations with contract history in a high-dimensional space. The AI model outputs scores for each interest category (e.g., home appliances, insurance, travel, health foods, etc.) to estimate which categories the customer is most interested in. For example, output examples such as “Home appliances: 0.85, Insurance: 0.60, Travel: 0.30” can be obtained. Furthermore, the AI model estimates future purchase predictions and uncontracted products from the combination of purchase and browsing history. Examples of AI input include purchase history tensor (e.g., [[101,20230101,5000,1,2,1,0,0,0,0], . . . ]), browsing history sequence (e.g., [[“www.example.com”,20230201,3,120,1], . . . ]), etc. Examples of AI output include interest category scores and lists of product IDs expected to be purchased next. Subsequent processing includes transmitting the estimated interest categories and product candidates to the specifying unit and prioritization unit for use in personalizing proposal content. As a technical effect, the analysis unit can extract the customer's latent needs and interests with high accuracy by integratively analyzing not only contract history but also purchase and browsing history. This enables improvements in computer technology, such as increased accuracy of cross-selling and up-selling, improved comprehensiveness of proposals, and enhanced customer satisfaction, which were difficult with conventional simple history reference. Application fields include e-commerce site recommendation engines, financial and insurance product proposals, measures to improve subscription service retention rates, and other areas requiring complex customer behavior analysis.

The analysis unit can consider the frequency of contracts and contract renewal history when analyzing the customer's contract history. For example, the analysis unit analyzes the customer's contract frequency to grasp contract trends. For instance, the analysis unit analyzes the customer's contract renewal history to predict renewal timing. Additionally, the analysis unit can evaluate future contract possibilities by combining contract frequency and renewal history. By considering contract frequency and renewal history, contract trends can be more accurately identified. Some or all of the above-described processing in the analysis unit may be performed using AI or without using AI. For example, the analysis unit may input the customer's contract renewal history data into generative AI and have the generative AI perform contract renewal analysis. Specifically, the analysis unit inputs contract history data for each customer (e.g., structured data including contract ID, contract start date, contract end date, contract amount, contract renewal date, number of renewals, cancellation date, etc.) as a time-series tensor (e.g., up to 100 records, each with 12 dimensions) into the AI model. The AI model uses time-series RNN or Transformer to extract patterns of renewal intervals and frequency. The AI model outputs contract renewal probabilities (e.g., next renewal probability 0.85, renewal within 3 months probability 0.60, etc.) and contract continuation tendency scores (e.g., 0.92). Furthermore, the AI model estimates future contract possibilities and cancellation risks from the combination of contract frequency and renewal history. Examples of AI input include contract history tensor (e.g., [[1,20210101,20220101,10000,20220101,2,0,0,0,0,0,0], . . . ]), etc. Examples of AI output include contract renewal probability 0.85, contract continuation score 0.92, cancellation risk 0.08, etc. Subsequent processing includes prioritizing renewal proposals for customers with high renewal probability and follow-up proposals for customers with high cancellation risk, optimizing proposal content. As a technical effect, the analysis unit can precisely grasp contract trends and detect contract renewal and cancellation risks early by analyzing contract frequency and renewal history as high-dimensional time-series data with AI, which was difficult with conventional simple history reference. This realizes essential improvements in computer technology, such as optimization of proposal timing, prevention of cancellations, and improvement of LTV (customer lifetime value). Application fields include contract management for telecommunications, insurance, and subscription services, measures to improve B2B transaction retention rates, financial product contract renewal proposals, and other areas requiring time-series analysis of contract history.

The analysis unit can estimate the customer's emotions and adjust the display method of the analysis results based on the estimated emotions of the customer. For example, if the customer is feeling stressed, the analysis unit displays the analysis results simply to reduce visual burden. If the customer is relaxed, the analysis unit displays detailed analysis results and provides abundant information. Additionally, if the customer is excited, the analysis unit displays the analysis results using visually attractive graphs and charts. By adjusting the display method of the analysis results according to the customer's emotions, it is possible to provide displays that are easy for the customer to understand. Emotion estimation is realized using an emotion engine or generative AI, for example, by employing emotion estimation functions. Generative AI may be, for example, text-generating AI (such as LLM) or multimodal generative AI, but is not limited to such examples. Some or all of the above-described processing in the analysis unit may be performed using AI or without using AI. For example, the analysis unit may input customer emotion data into generative AI and have the generative AI perform emotion estimation. Specifically, the analysis unit accepts multimodal data as input for customer emotion estimation, such as voice data (e.g., conversation audio waveform data), text data (e.g., chat history), and facial images (e.g., face images 128×128 pixels). The analysis unit performs preprocessing on these data (e.g., voice feature extraction, facial landmark detection, morphological analysis of text) and inputs them into a multimodal neural network for emotion estimation (e.g., CNN+RNN for voice, CNN for images, Transformer for text). The AI model outputs a probability distribution for each emotion category (e.g., stress, relaxation, excitement, etc.). The analysis unit selects the emotion category with the highest probability and transmits it to the display method selection module. For example, if stress is high, a simple display with only text is selected; if relaxed, a display including detailed numerical values and graphs is selected; if excited, a display using animated graphs and charts is selected. Examples of AI input include audio waveform data, chat text such as “I am satisfied with my recent contract,” and facial image data. Examples of AI output include emotion category “stress” probability 0.8, “relaxation” probability 0.1, “excitement” probability 0.1, etc. Subsequent processing includes dynamically switching the GUI display layout, color scheme, and amount of information according to the emotion category. As a technical effect, the analysis unit optimizes the display method of analysis results according to the customer's emotional state, improving the customer's understanding and satisfaction and enhancing information transmission efficiency. It can flexibly respond to diverse customer states that could not be addressed by conventional uniform displays, improving the quality of customer experience. Application fields include call center support, online customer service, medical consultations, personalized learning support in education, and other scenes where information presentation according to emotional state is required.

The analysis unit can consider the customer's geographic location information when analyzing the customer's contract history. For example, the analysis unit collects the customer's residence information and analyzes it in relation to the contract history. For instance, the analysis unit analyzes the customer's movement history and evaluates its relevance to the contract history. Additionally, the analysis unit can analyze contract history based on the customer's geographic location information and analyze contract trends for each region. By considering the customer's geographic location information, contract trends for each region can be identified. Some or all of the above-described processing in the analysis unit may be performed using AI or without using AI. For example, the analysis unit may input the customer's geographic location information data into generative AI and have the generative AI perform geographic location information analysis. Specifically, the analysis unit collects the customer's residence information (e.g., prefecture, city/ward/town/village, postal code as categorical data) and movement history (e.g., GPS coordinates, movement date and time, movement distance, destination category as time-series data). The analysis unit vectorizes these data, encodes residence information as one-hot encoding, and inputs movement history as a time-series tensor (e.g., up to 365 records, each with 5 dimensions) into the AI model. The AI model uses a neural network for geographic feature extraction (e.g., time-series RNN+geographic clustering layer) to analyze correlations between contract history and geographic information. The AI model outputs contract trend scores for each region (e.g., urban area 0.85, suburban area 0.60, rural area 0.30) and product demand forecasts based on movement patterns (e.g., increased insurance demand within commuting areas). Examples of AI input include residence “Shinjuku-ku, Tokyo,” movement history tensor (e.g., [[35.6895,139.6917,20230101,5.2,1], . . . ]), etc. Examples of AI output include region category “urban area” contract trend 0.85, movement pattern “commuting type” demand forecast 0.75, etc. Subsequent processing includes product proposals according to contract trends for each region and targeting based on movement patterns. As a technical effect, the analysis unit can precisely grasp regional characteristics and predict demand based on movement patterns by analyzing geographic location information as high-dimensional data with AI, which was difficult with conventional simple residence reference. This realizes essential improvements in computer technology, such as region-optimized proposals, advanced product placement strategies, and improved marketing efficiency for each region. Application fields include region-specific proposals for telecommunications, insurance, and retail, targeting in the tourism industry, urban planning support, and other proposal operations utilizing geographic information.

The analysis unit can analyze the customer's social media activities and obtain relevant information when analyzing the customer's contract history. For example, the analysis unit collects the customer's social media posts and analyzes them in relation to the contract history. For instance, the analysis unit analyzes the customer's interests and concerns on social media and evaluates their relevance to the contract history. Additionally, the analysis unit can analyze the frequency of the customer's social media activities and examine correlations with the contract history. By analyzing the customer's social media activities, the customer's interests and concerns can be identified. Some or all of the above-described processing in the analysis unit may be performed using AI or without using AI. For example, the analysis unit may input the customer's social media data into generative AI and have the generative AI perform social media activity analysis. Specifically, the analysis unit collects data for analyzing the customer's social media activities, such as post text data (e.g., up to 1000 posts, each post up to 512 tokens of natural language text), post date and time, images attached to posts (e.g., 128×128 pixel images), and engagement metrics such as “likes” and “shares” (e.g., numerical reaction counts for each post). The analysis unit performs preprocessing on these data, such as morphological analysis and tokenization for text, face detection and object recognition for images, and normalization for engagement, and generates feature vectors for each post (e.g., text embedding vector, image feature vector, engagement score). The analysis unit inputs these feature vectors as a time-series tensor (e.g., 1000 records×50 dimensions) into the AI model. The analysis unit uses a Transformer-based multimodal neural network to analyze correlations among post content, images, and engagement in a high-dimensional space, and outputs scores for each interest category (e.g., sports, travel, health, finance, home appliances, etc.) for each uncontracted product candidate. For example, the AI model outputs scores such as “Product A: 0.82, Product B: 0.65, Product C: 0.40.” Furthermore, the AI model extracts changes in customer interests and trends from time-series patterns of post frequency and engagement. Examples of AI input include post text “I bought a new smartwatch,” post image data, engagement score “likes: 25, shares: 3,” etc. Examples of AI output include uncontracted product ID 10: 0.90, ID 12: 0.60, post frequency trend “increasing,” etc. Subsequent processing includes integrating the extracted interest categories and trend information with contract history data and using them for identifying uncontracted products and personalizing proposal priorities. As a technical effect, the analysis unit can extract real-time changes in customer interests, concerns, and lifestyle with high accuracy, which could not be grasped with conventional contract or purchase history alone. This enables significant improvement in the degree of proposal personalization, product acquisition rates, customer satisfaction, and accuracy of cross-selling and up-selling, realizing essential improvements in computer technology. Application fields include proposal operations utilizing social media activities, such as proposals for telecommunications services, insurance and financial products, e-commerce site recommendation engines, B2B sales support, and personalized advertising distribution.

The specifying unit can estimate the customer's emotions and adjust the method of identifying uncontracted products based on the estimated emotions of the customer. For example, if the customer is feeling stressed, the specifying unit selects a simple identification method and quickly identifies uncontracted products. If the customer is relaxed, the specifying unit selects a detailed identification method and considers more data. Additionally, if the customer is excited, the specifying unit provides visually easy-to-understand identification results. By adjusting the identification method according to the customer's emotions, more appropriate uncontracted products can be identified. Emotion estimation is realized using an emotion engine or generative AI, for example, by employing emotion estimation functions. Generative AI may be, for example, text-generating AI (such as LLM) or multimodal generative AI, but is not limited to such examples. Some or all of the above-described processing in the specifying unit may be performed using AI or without using AI. For example, the specifying unit may input customer emotion data into generative AI and have the generative AI perform emotion estimation. Specifically, the specifying unit accepts multimodal data as input for customer emotion estimation, such as voice data (e.g., conversation audio waveform data, 16 kHz sampling, 30 seconds), text data (e.g., chat history, 500 tokens), and facial images (e.g., face images 128×128 pixels). The specifying unit performs preprocessing on these data (voice feature extraction, facial landmark detection, morphological analysis of text) and inputs them into a multimodal neural network for emotion estimation (CNN+RNN for voice, CNN for images, Transformer for text). The AI model outputs a probability distribution for each emotion category (e.g., stress, relaxation, excitement, sadness, joy). The specifying unit selects the emotion category with the highest probability and transmits it to the identification method selection module. For example, if stress is high, a simple identification algorithm using only major features of the contract history (contract amount, contract period, cancellation status, etc.) is selected; if relaxed, a detailed identification algorithm using all features (contract options, usage frequency, related products, purchase history, web browsing history, etc.) is selected; if excited, a display mode that visualizes identification results as graphs or charts is selected. Examples of AI input include audio waveform data, chat text such as “I am interested in new services,” and facial image data. Examples of AI output include emotion category “relaxation” probability 0.6, “stress” probability 0.3, “excitement” probability 0.1, etc. Subsequent processing includes branching of identification algorithms and switching of identification result display methods according to the emotion category. As a technical effect, the specifying unit dynamically optimizes the method of identifying uncontracted products according to the customer's emotional state, achieving both improved customer experience and identification accuracy. It can flexibly respond to diverse customer states that could not be addressed by conventional uniform identification methods, improving the persuasiveness and utility of identification results. Application fields include call center support, online customer service, medical consultations, personalized learning support in education, and other scenes where information analysis according to emotional state is required.

The specifying unit can consider not only the customer's past contract history but also the customer's purchase history and website browsing history when identifying uncontracted products. For example, the specifying unit collects the customer's past purchase history and identifies uncontracted products in combination with the contract history. For instance, the specifying unit collects the customer's website visit history and identifies uncontracted products in relation to the contract history. Additionally, the specifying unit can analyze the customer's online shopping history and compare it with the contract history to identify uncontracted products. By considering the customer's purchase history and website browsing history, more detailed uncontracted products can be identified. Some or all of the above-described processing in the specifying unit may be performed using AI or without using AI. For example, the specifying unit may input the customer's purchase history data into generative AI and have the generative AI perform purchase history analysis. Specifically, the specifying unit collects the customer's purchase history data (e.g., records in a structured database including product ID, purchase date, purchase amount, category, quantity, payment method, etc.) and website browsing history (e.g., URL, access date and time, page category, time spent, etc.). The specifying unit vectorizes these data, inputs purchase history as a time-series tensor (e.g., up to 200 records, each with 10 dimensions) and browsing history as a sequence data arranged in access order (e.g., up to 500 records, each with 5 dimensions) into the AI model. The specifying unit uses Transformer or time-series RNN to extract patterns of purchase and browsing behavior and analyzes correlations with contract history in a high-dimensional space. The AI model outputs relevance scores (e.g., continuous values from 0.0 to 1.0) for each uncontracted product candidate based on purchase and browsing history. For example, output examples such as “Product A: 0.85, Product B: 0.60, Product C: 0.30” can be obtained. Furthermore, the AI model estimates future purchase predictions and uncontracted products from the combination of purchase and browsing history. Examples of AI input include purchase history tensor (e.g., [[101,20230101,5000,1,2,1,0,0,0,0], . . . ]), browsing history sequence (e.g., [“www.example.com”,20230201,3,120,1], . . . ), etc. Examples of AI output include uncontracted product ID 5: 0.92, ID 7:0.75, ID 9:0.31, and recommendation reason text such as “Product 5 matches past purchase trends.” Subsequent processing includes adopting only the top-scoring products as identification results and transmitting the identification results to the prioritization unit and display unit. As a technical effect, the specifying unit can extract the customer's latent needs and interests with high accuracy by integratively analyzing not only contract history but also purchase and browsing history. This enables improvements in computer technology, such as increased accuracy of cross-selling and up-selling, improved comprehensiveness of proposals, and enhanced customer satisfaction, which were difficult with conventional simple history reference. Application fields include e-commerce site recommendation engines, financial and insurance product proposals, measures to improve subscription service retention rates, and other areas requiring complex customer behavior analysis.

The specifying unit can consider the popularity of products and market trends when identifying uncontracted products. For example, the specifying unit collects product popularity data and uses it for identifying uncontracted products. For instance, the specifying unit analyzes market trend information and reflects it in the identification of uncontracted products. Additionally, the specifying unit can combine product popularity and market trends to identify the most suitable uncontracted products. By considering product popularity and market trends, more appropriate uncontracted products can be identified. Some or all of the above-described processing in the specifying unit may be performed using AI or without using AI. For example, the specifying unit may input product popularity data into generative AI and have the generative AI perform popularity analysis. Specifically, the specifying unit collects sales performance data for each product (e.g., product ID, number of sales, sales period, repeat rate, campaign response rate, etc.) and market trend data (e.g., search volume, number of SNS posts, frequency of industry news, seasonality index, etc.). The specifying unit vectorizes these data, generates feature vectors (e.g., 20 dimensions) for each product, and inputs them into the AI model. The AI model uses time-series RNN or graph neural networks to analyze changes in popularity and market trends and outputs “market suitability scores” (e.g., continuous values from 0.0 to 1.0) for each uncontracted product candidate. For example, output examples such as “Product A: 0.88, Product B: 0.65, Product C: 0.40” can be obtained. Furthermore, the AI model extracts products expected to have increased demand in the future from the combination of popularity and trends. Examples of AI input include product ID “101,” number of sales “5000,” search volume “20000,” number of SNS posts “1500,” etc. Examples of AI output include market suitability score “0.92,” trend increase prediction “yes,” etc. Subsequent processing includes prioritizing the top-scoring uncontracted products as proposal candidates and optimizing proposal content. As a technical effect, the specifying unit can quickly respond to market changes and improve proposal accuracy based on demand forecasts by analyzing product popularity and market trends as high-dimensional data with AI, which was difficult with conventional simple sales performance reference. This realizes essential improvements in computer technology, such as optimization of proposal timing, increased product acquisition rates, and improved marketing efficiency. Application fields include new product proposals for telecommunications, insurance, and retail, trend recommendations for e-commerce sites, market analysis support for B2B sales, and other proposal operations utilizing market trends.

The specifying unit can estimate the customer's emotions and adjust the display method of the identified uncontracted products based on the estimated emotions of the customer. For example, if the customer is feeling stressed, the specifying unit displays the identified uncontracted products simply to reduce visual burden. If the customer is relaxed, the specifying unit provides a display method including detailed information. Additionally, if the customer is excited, the specifying unit displays uncontracted products using visually attractive graphs and charts. By adjusting the display method according to the customer's emotions, it is possible to provide displays that are easy for the customer to understand. Emotion estimation is realized using an emotion engine or generative AI, for example, by employing emotion estimation functions. Generative AI may be, for example, text-generating AI (such as LLM) or multimodal generative AI, but is not limited to such examples. Some or all of the above-described processing in the specifying unit may be performed using AI or without using AI. For example, the specifying unit may input customer emotion data into generative AI and have the generative AI perform emotion estimation. Specifically, the specifying unit accepts multimodal data as input for customer emotion estimation, such as voice data (e.g., conversation audio waveform data, 16 kHz sampling, 30 seconds), text data (e.g., chat history, 500 tokens), and facial images (e.g., face images 128×128 pixels). The specifying unit performs preprocessing on these data (voice feature extraction, facial landmark detection, morphological analysis of text) and inputs them into a multimodal neural network for emotion estimation (CNN+RNN for voice, CNN for images, Transformer for text). The AI model outputs a probability distribution for each emotion category (e.g., stress, relaxation, excitement, sadness, joy). The specifying unit selects the emotion category with the highest probability and transmits it to the display method selection module. For example, if stress is high, a simple display with only text is selected; if relaxed, a display including detailed numerical values and graphs is selected; if excited, a display using animated graphs and charts is selected. Examples of AI input include audio waveform data, chat text such as “I am interested in new services,” and facial image data. Examples of AI output include emotion category “relaxation” probability 0.6, “stress” probability 0.3, “excitement” probability 0.1, etc. Subsequent processing includes dynamically switching the GUI display layout, color scheme, and amount of information according to the emotion category. As a technical effect, the specifying unit optimizes the display method of uncontracted products according to the customer's emotional state, improving the customer's understanding and satisfaction and enhancing information transmission efficiency. It can flexibly respond to diverse customer states that could not be addressed by conventional uniform displays, improving the quality of customer experience. Application fields include call center support, online customer service, medical consultations, personalized learning support in education, and other scenes where information presentation according to emotional state is required.

The specifying unit can consider the customer's geographic location information when identifying uncontracted products. For example, the specifying unit collects the customer's residence information and uses it for identifying uncontracted products. For instance, the specifying unit analyzes the customer's movement history and reflects it in the identification of uncontracted products. Additionally, the specifying unit can identify uncontracted products for each region based on the customer's geographic location information. By considering the customer's geographic location information, uncontracted products for each region can be identified. Some or all of the above-described processing in the specifying unit may be performed using AI or without using AI. For example, the specifying unit may input the customer's geographic location information data into generative AI and have the generative AI perform geographic location information analysis. Specifically, the specifying unit collects the customer's residence information (e.g., prefecture, city/ward/town/village, postal code as categorical data) and movement history (e.g., GPS coordinates, movement date and time, movement distance, destination category as time-series data). The specifying unit vectorizes these data, encodes residence information as one-hot encoding, and inputs movement history as a time-series tensor (e.g., up to 365 records, each with 5 dimensions) into the AI model. The specifying unit uses a neural network for geographic feature extraction (e.g., time-series RNN+geographic clustering layer) to analyze correlations between contract history and geographic information. The AI model outputs region suitability scores (e.g., urban area 0.85, suburban area 0.60, rural area 0.30) and product demand forecasts based on movement patterns (e.g., increased insurance demand within commuting areas) for each uncontracted product candidate. Examples of AI input include residence “Shinjuku-ku, Tokyo,” movement history tensor (e.g., [[35.6895,139.6917,20230101,5.2,1], . . . ]), etc. Examples of AI output include region category “urban area” contract trend 0.85, movement pattern “commuting type” demand forecast 0.75, etc. Subsequent processing includes identification of uncontracted products according to contract trends for each region and targeting based on movement patterns. As a technical effect, the specifying unit can precisely grasp regional characteristics and predict demand based on movement patterns by analyzing geographic location information as high-dimensional data with AI, which was difficult with conventional simple residence reference. This realizes essential improvements in computer technology, such as region-optimized identification of uncontracted products, advanced product placement strategies, and improved marketing efficiency for each region. Application fields include region-specific proposals for telecommunications, insurance, and retail, targeting in the tourism industry, urban planning support, and other proposal operations utilizing geographic information.

The specifying unit can analyze the customer's social media activities and identify relevant products when identifying uncontracted products. For example, the specifying unit collects the customer's social media posts and uses them for identifying uncontracted products. For instance, the specifying unit analyzes the customer's interests and concerns on social media and reflects them in the identification of uncontracted products. Additionally, the specifying unit can analyze the frequency of the customer's social media activities and use it for identifying uncontracted products. By analyzing the customer's social media activities, products based on the customer's interests and concerns can be identified. Some or all of the above-described processing in the specifying unit may be performed using AI or without using AI. For example, the specifying unit may input the customer's social media data into generative AI and have the generative AI perform social media activity analysis. Specifically, the specifying unit collects data for analyzing the customer's social media activities, such as post text data (e.g., up to 1000 posts, each post up to 512 tokens of natural language text), post date and time, images attached to posts (e.g., 128×128 pixel images), and engagement metrics such as “likes” and “shares” (e.g., numerical reaction counts for each post). The specifying unit performs preprocessing on these data, such as morphological analysis and tokenization for text, face detection and object recognition for images, and normalization for engagement, and generates feature vectors for each post (e.g., text embedding vector, image feature vector, engagement score). The specifying unit inputs these feature vectors as a time-series tensor (e.g., 1000 records×50 dimensions) into the AI model. The specifying unit uses a Transformer-based multimodal neural network to analyze correlations among post content, images, and engagement in a high-dimensional space, and outputs interest category scores and relevance scores for each uncontracted product candidate. For example, the AI model outputs scores such as “Product A: 0.82, Product B: 0.65, Product C: 0.40.” Furthermore, the AI model extracts changes in customer interests and trends from time-series patterns of post frequency and engagement. Examples of AI input include post text “I bought a new smartwatch,” post image data, engagement score “likes: 25, shares: 3,” etc. Examples of AI output include uncontracted product ID 10: 0.90, ID 12: 0.60, post frequency trend “increasing,” etc. Subsequent processing includes integrating the extracted interest categories and trend information with contract history data and using them for identifying uncontracted products and personalizing proposal priorities. As a technical effect, the specifying unit can extract real-time changes in customer interests, concerns, and lifestyle with high accuracy, which could not be grasped with conventional contract or purchase history alone. This enables significant improvement in the degree of proposal personalization, product acquisition rates, customer satisfaction, and accuracy of cross-selling and up-selling, realizing essential improvements in computer technology. Application fields include proposal operations utilizing social media activities, such as proposals for telecommunications services, insurance and financial products, e-commerce site recommendation engines, B2B sales support, and personalized advertising distribution.

The prioritization unit can estimate the customer's emotions and adjust the proposal priorities based on the estimated emotions of the customer. For example, if the customer is feeling stressed, the prioritization unit prioritizes simple proposals. If the customer is relaxed, the prioritization unit prioritizes detailed proposals. Additionally, if the customer is excited, the prioritization unit prioritizes visually attractive proposals. By adjusting the proposal priorities according to the customer's emotions, more appropriate proposals can be made. Emotion estimation is realized using an emotion engine or generative AI, for example, by employing emotion estimation functions. Generative AI may be, for example, text-generating AI (such as LLM) or multimodal generative AI, but is not limited to such examples. Some or all of the above-described processing in the prioritization unit may be performed using AI or without using AI. For example, the prioritization unit may input customer emotion data into generative AI and have the generative AI perform emotion estimation. Specifically, the prioritization unit accepts multimodal data as input for customer emotion estimation, such as voice data (e.g., conversation audio waveform data, 16 kHz sampling, 30 seconds), text data (e.g., chat history, 500 tokens), and facial images (e.g., face images 128×128 pixels). The prioritization unit performs preprocessing on these data (voice feature extraction, facial landmark detection, morphological analysis of text) and inputs them into a multimodal neural network for emotion estimation (CNN+RNN for voice, CNN for images, Transformer for text). The AI model outputs a probability distribution for each emotion category (e.g., stress, relaxation, excitement, sadness, joy). The prioritization unit selects the emotion category with the highest probability and transmits it to the priority adjustment module. For example, if stress is high, a simple prioritization algorithm using only major features of contract history and purchase history (contract amount, contract period, cancellation status, etc.) is selected; if relaxed, a detailed prioritization algorithm using all features (contract options, usage frequency, related products, purchase history, web browsing history, etc.) is selected; if excited, a display mode that visualizes prioritization results as graphs or charts is selected. Examples of AI input include audio waveform data, chat text such as “I am interested in new services,” and facial image data. Examples of AI output include emotion category “relaxation” probability 0.6, “stress” probability 0.3, “excitement” probability 0.1, etc. Subsequent processing includes branching of prioritization algorithms and switching of prioritization result display methods according to the emotion category. As a technical effect, the prioritization unit dynamically optimizes the method of determining proposal priorities according to the customer's emotional state, achieving both improved customer experience and proposal accuracy. It can flexibly respond to diverse customer states that could not be addressed by conventional uniform prioritization methods, improving the persuasiveness and utility of proposal results. Application fields include call center support, online customer service, medical consultations, personalized learning support in education, and other scenes where information analysis according to emotional state is required.

The prioritization unit can consider not only the customer's past contract history but also the customer's purchase history and website browsing history when assigning proposal priorities. For example, the prioritization unit collects the customer's past purchase history and assigns proposal priorities in combination with the contract history. For instance, the prioritization unit collects the customer's website visit history and assigns proposal priorities in relation to the contract history. Additionally, the prioritization unit can analyze the customer's online shopping history and compare it with the contract history to assign proposal priorities. By considering the customer's purchase history and website browsing history, more detailed proposal priorities can be assigned. Some or all of the above-described processing in the prioritization unit may be performed using AI or without using AI. For example, the prioritization unit may input the customer's purchase history data into generative AI and have the generative AI perform purchase history analysis. Specifically, the prioritization unit collects the customer's purchase history data (e.g., records in a structured database including product ID, purchase date, purchase amount, category, quantity, payment method, etc.) and website browsing history (e.g., URL, access date and time, page category, time spent, etc.). The prioritization unit vectorizes these data, inputs purchase history as a time-series tensor (e.g., up to 200 records, each with 10 dimensions) and browsing history as a sequence data arranged in access order (e.g., up to 500 records, each with 5 dimensions) into the AI model. The prioritization unit uses Transformer or time-series RNN to extract patterns of purchase and browsing behavior and analyzes correlations with contract history in a high-dimensional space. The AI model outputs relevance scores (e.g., continuous values from 0.0 to 1.0) for each proposal candidate product based on purchase and browsing history. For example, output examples such as “Product A: 0.85, Product B: 0.60, Product C: 0.30” can be obtained. Furthermore, the AI model estimates future purchase predictions and proposal candidates from the combination of purchase and browsing history. Examples of AI input include purchase history tensor (e.g., [[101,20230101,5000,1,2,1,0,0,0,0], . . . ]), browsing history sequence (e.g., [‘www.example.com’,20230201,3,120,1], . . . ), etc. Examples of AI output include proposal candidate product ID 5: 0.92, ID 7: 0.75, ID 9: 0.31, and recommendation reason text such as “Product 5 matches past purchase trends.” Subsequent processing includes adopting only the top-scoring products as prioritization results and transmitting the prioritization results to the display unit and notification module. As a technical effect, the prioritization unit can extract the customer's latent needs and interests with high accuracy by integratively analyzing not only contract history but also purchase and browsing history. This enables improvements in computer technology, such as increased accuracy of cross-selling and up-selling, improved comprehensiveness of proposals, and enhanced customer satisfaction, which were difficult with conventional simple history reference. Application fields include e-commerce site recommendation engines, financial and insurance product proposals, measures to improve subscription service retention rates, and other areas requiring complex customer behavior analysis.

The prioritization unit can consider the popularity of products and market trends when assigning proposal priorities. For example, the prioritization unit collects product popularity data and reflects it in proposal priorities. For instance, the prioritization unit analyzes market trend information and reflects it in proposal priorities. Additionally, the prioritization unit can combine product popularity and market trends to assign the most suitable proposal priorities. By considering product popularity and market trends, more appropriate proposal priorities can be assigned. Some or all of the above-described processing in the prioritization unit may be performed using AI or without using AI. For example, the prioritization unit may input product popularity data into generative AI and have the generative AI perform popularity analysis. Specifically, the prioritization unit collects sales performance data for each product (e.g., product ID, number of sales, sales period, repeat rate, campaign response rate, etc.) and market trend data (e.g., search volume, number of SNS posts, frequency of industry news, seasonality index, etc.). The prioritization unit vectorizes these data, generates feature vectors (e.g., 20 dimensions) for each product, and inputs them into the AI model. The AI model uses time-series RNN or graph neural networks to analyze changes in popularity and market trends and outputs “market suitability scores” (e.g., continuous values from 0.0 to 1.0) for each proposal candidate product. For example, output examples such as “Product A: 0.88, Product B: 0.65, Product C: 0.40” can be obtained. Furthermore, the AI model extracts products expected to have increased demand in the future from the combination of popularity and trends. Examples of AI input include product ID “101,” number of sales “5000,” search volume “20000,” number of SNS posts “1500,” etc. Examples of AI output include market suitability score “0.92,” trend increase prediction “yes,” etc. Subsequent processing includes prioritizing the top-scoring products as proposal candidates and optimizing proposal content. As a technical effect, the prioritization unit can quickly respond to market changes and improve proposal accuracy based on demand forecasts by analyzing product popularity and market trends as high-dimensional data with AI, which was difficult with conventional simple sales performance reference. This realizes essential improvements in computer technology, such as optimization of proposal timing, increased product acquisition rates, and improved marketing efficiency. Application fields include new product proposals for telecommunications, insurance, and retail, trend recommendations for e-commerce sites, market analysis support for B2B sales, and other proposal operations utilizing market trends.

The prioritization unit can estimate the customer's emotions and adjust the display method of the prioritization results based on the estimated emotions of the customer. For example, if the customer is feeling stressed, the prioritization unit displays the prioritization results simply to reduce visual burden. If the customer is relaxed, the prioritization unit provides a display method including detailed information. Additionally, if the customer is excited, the prioritization unit displays the prioritization results using visually attractive graphs and charts. By adjusting the display method according to the customer's emotions, it is possible to provide displays that are easy for the customer to understand. Emotion estimation is realized using an emotion engine or generative AI, for example, by employing emotion estimation functions. Generative AI may be, for example, text-generating AI (such as LLM) or multimodal generative AI, but is not limited to such examples. Some or all of the above-described processing in the prioritization unit may be performed using AI or without using AI. For example, the prioritization unit may input customer emotion data into generative AI and have the generative AI perform emotion estimation. Specifically, the prioritization unit accepts multimodal data as input for customer emotion estimation, such as voice data (e.g., conversation audio waveform data, 16 kHz sampling, 30 seconds), text data (e.g., chat history, 500 tokens), and facial images (e.g., face images 128×128 pixels). The prioritization unit performs preprocessing on these data (voice feature extraction, facial landmark detection, morphological analysis of text) and inputs them into a multimodal neural network for emotion estimation (CNN+RNN for voice, CNN for images, Transformer for text). The AI model outputs a probability distribution for each emotion category (e.g., stress, relaxation, excitement, sadness, joy). The prioritization unit selects the emotion category with the highest probability and transmits it to the display method selection module. For example, if stress is high, a simple display with only text is selected; if relaxed, a display including detailed numerical values and graphs is selected; if excited, a display using animated graphs and charts is selected. Examples of AI input include audio waveform data, chat text such as “I am satisfied with my recent contract,” and facial image data. Examples of AI output include emotion category “stress” probability 0.8, “relaxation” probability 0.1, “excitement” probability 0.1, etc. Subsequent processing includes dynamically switching the GUI display layout, color scheme, and amount of information according to the emotion category. As a technical effect, the prioritization unit optimizes the display method of prioritization results according to the customer's emotional state, improving the customer's understanding and satisfaction and enhancing information transmission efficiency. It can flexibly respond to diverse customer states that could not be addressed by conventional uniform displays, improving the quality of customer experience. Application fields include call center support, online customer service, medical consultations, personalized learning support in education, and other scenes where information presentation according to emotional state is required.

The prioritization unit can consider the customer's geographic location information when determining proposal priorities. For example, the prioritization unit collects the customer's residence information and reflects it in proposal priorities. For instance, the prioritization unit analyzes the customer's movement history and reflects it in proposal priorities. Additionally, the prioritization unit can determine proposal priorities for each region based on the customer's geographic location information. By considering the customer's geographic location information, proposal priorities for each region can be determined. Some or all of the above-described processing in the prioritization unit may be performed using AI or without using AI. For example, the prioritization unit may input the customer's geographic location information data into generative AI and have the generative AI perform geographic location information analysis. Specifically, the prioritization unit collects the customer's residence information (e.g., prefecture, city/ward/town/village, postal code as categorical data) and movement history (e.g., GPS coordinates, movement date and time, movement distance, destination category as time-series data). The prioritization unit vectorizes these data, encodes residence information as one-hot encoding, and inputs movement history as a time-series tensor (e.g., up to 365 records, each with 5 dimensions) into the AI model. The prioritization unit uses a neural network for geographic feature extraction (e.g., time-series RNN+geographic clustering layer) to analyze correlations between contract history and geographic information. The AI model outputs region suitability scores (e.g., urban area 0.85, suburban area 0.60, rural area 0.30) and product demand forecasts based on movement patterns (e.g., increased insurance demand within commuting areas) for each proposal candidate product. Examples of AI input include residence “Shinjuku-ku, Tokyo,” movement history tensor (e.g., [[35.6895,139.6917,20230101,5.2,1], . . . ]), etc. Examples of AI output include region category “urban area” contract trend 0.85, movement pattern “commuting type” demand forecast 0.75, etc. Subsequent processing includes optimization of proposal priorities and advanced regional targeting strategies according to contract trends and movement patterns for each region. As a technical effect, the prioritization unit can precisely grasp regional characteristics and predict demand based on movement patterns by analyzing geographic location information as high-dimensional data with AI, which was difficult with conventional simple residence reference. This realizes essential improvements in computer technology, such as region-optimized proposals, advanced product placement strategies, and improved marketing efficiency for each region. Application fields include region-specific proposals for telecommunications, insurance, and retail, targeting in the tourism industry, urban planning support, and other proposal operations utilizing geographic information.

The prioritization unit can analyze the customer's social media activities and take relevant information into account when assigning proposal priorities. For example, the prioritization unit collects the customer's social media posts and reflects them in the proposal priorities. The prioritization unit may analyze the customer's interests and concerns on social media and reflect them in the proposal priorities. Additionally, the prioritization unit can analyze the frequency of the customer's social media activities and reflect this in the proposal priorities. By analyzing the customer's social media activities, proposal priorities can be assigned based on the customer's interests and concerns. Some or all of the above-described processes in the prioritization unit may be performed using AI or without using AI. For example, the prioritization unit may input the customer's social media data into a generative AI and have the generative AI perform the analysis of social media activities. Specifically, the prioritization unit collects data for analyzing the customer's social media activities, such as post text data (e.g., up to 1,000 posts, each post up to 512 tokens of natural language text), post timestamps, images associated with posts (e.g., 128×128 pixel images), and engagement metrics such as ‘likes’ and ‘shares’ (e.g., the number of reactions quantified for each post). As preprocessing, the prioritization unit performs morphological analysis and tokenization for text, face detection and object recognition for images, and normalization for engagement, generating feature vectors for each post (e.g., text embedding vectors, image feature vectors, engagement scores). These features are input to the AI model as a time-series tensor (e.g., 1,000 posts×50 dimensions). The prioritization unit uses a Transformer-based multimodal neural network to analyze the correlations among post content, images, and engagement in a high-dimensional space, outputting interest category scores and relevance scores for each proposal candidate product. For example, the AI model may output scores such as ‘Product A: 0.82, Product B: 0.65, Product C: 0.40.’ Furthermore, the AI model extracts changes in customer interests and trends from time-series patterns of posting frequency and engagement. Example AI inputs include post text such as ‘I bought a new smartwatch,’ post image data, and engagement scores such as ‘likes: 25, shares: 3.’ Example AI outputs include proposal candidate product ID 10: 0.90, ID 12: 0.60, posting frequency trend ‘increasing,’ and so on. In subsequent processing, the extracted interest categories and trend information are integrated with contract history data and used to personalize proposal priorities. As a technical effect, the prioritization unit can extract real-time changes in customer interests, concerns, and lifestyle with high accuracy, which could not be captured by conventional contract or purchase history alone. This greatly improves the degree of personalization of proposals, increases product acquisition rates and customer satisfaction, and enhances the accuracy of cross-selling and up-selling, thereby achieving essential improvements in computer technology. Application fields include proposal operations utilizing social media activities, such as telecommunications services, insurance and financial product proposals, e-commerce site recommendation engines, B2B sales support, and personalized ad delivery.

The display unit can estimate the customer's emotions and adjust the display method of proposal points based on the estimated emotions. For example, if the customer is feeling stressed, the display unit presents proposal points in a simple manner to reduce visual burden. If the customer is relaxed, the display unit provides a display method that includes detailed information. Additionally, if the customer is excited, the display unit uses visually appealing graphs and charts to display proposal points. By adjusting the display method according to the customer's emotions, the display can be made easier for the customer to understand. Emotion estimation is realized using, for example, an emotion engine or generative AI with emotion estimation functions. Generative AI may include text generation AI (e.g., LLM) or multimodal generative AI, but is not limited to these examples. Some or all of the above-described processes in the display unit may be performed using AI or without using AI. For example, the display unit may input customer emotion data into a generative AI and have the generative AI perform emotion estimation. Specifically, the display unit accepts multimodal data for customer emotion estimation, such as voice data (e.g., conversational audio waveform data, 16 kHz sampling, 30 seconds), text data (e.g., chat history, 500 tokens), and facial images (e.g., face images 128×128 pixels). The display unit preprocesses these data (voice feature extraction, facial landmark detection, morphological analysis of text) and inputs them into a multimodal neural network for emotion estimation (voice: CNN+RNN, image: CNN, text: Transformer). The AI model outputs probability distributions for each emotion category (e.g., stress 0.7, relaxation 0.2, excitement 0.1). The display unit selects the emotion category with the highest probability and transmits it to the display method selection module. For example, if stress is high, a simple text-only display is selected; if relaxed, a display including detailed numerical data and graphs; if excited, a display using animated graphs and charts. Example AI inputs include audio waveform data, chat text such as ‘I am interested in the new service,’ and facial image data. Example AI outputs include emotion category ‘relaxation’ probability 0.6, ‘stress’ probability 0.3, ‘excitement’ probability 0.1, and so on. In subsequent processing, the display layout, color scheme, and amount of information in the GUI are dynamically switched according to the emotion category. The display unit performs real-time switching of display modes and applies different templates or style sheets to the rendering engine for each emotion category. For example, during stress, the background color is set to a calm tone and the amount of information is minimized; during relaxation, detailed statistical graphs and related information are displayed in multiple layers; during excitement, interactive animations and dynamic charts are used to provide information optimized for the user's emotional state. As a technical effect, the display unit optimizes the display method of proposal points according to the customer's emotional state, thereby improving the customer's understanding and acceptance and enhancing information transmission efficiency. It can flexibly respond to diverse customer states that could not be addressed by conventional uniform displays, improving the quality of customer experience. Application fields include call center support, online customer service, medical consultations, personalized learning support in education, and any scene where information presentation according to emotional state is required.

The display unit can display, in addition to the customer's past contract history, the customer's purchase history and website browsing history when presenting proposal points. For example, the display unit collects the customer's past purchase history and displays proposal points in combination with the contract history. The display unit may also collect the customer's website visit history and display proposal points in association with the contract history. Additionally, the display unit can analyze the customer's online shopping history and display proposal points by cross-referencing with the contract history. By displaying the customer's purchase history and website browsing history, more detailed proposal points can be provided. Some or all of the above-described processes in the display unit may be performed using AI or without using AI. For example, the display unit may input the customer's purchase history data into a generative AI and have the generative AI perform the analysis of the purchase history. Specifically, the display unit collects the customer's purchase history data (e.g., records in a structured database including product ID, purchase date, purchase amount, category, quantity, payment method, etc.) and website browsing history (e.g., log data such as URL, access date and time, page category, time spent, etc.). These data are vectorized, with purchase history as a time-series tensor (e.g., up to 200 items, each with 10 dimensions) and browsing history as sequence data arranged in access order (e.g., up to 500 items, each with 5 dimensions), and input into the AI model. The display unit uses Transformer or time-series RNN to extract patterns of purchase and browsing behavior and analyzes correlations with contract history in a high-dimensional space. The AI model outputs, for each proposal point, relevance scores with purchase and browsing history (e.g., continuous values from 0.0 to 1.0) and recommendation reason texts (e.g., ‘Product A matches past purchase trends’). Example AI inputs include purchase history tensors (e.g., [[101,20230101,5000,1,2,1,0,0,0,0], . . . ]), browsing history sequences (e.g., [‘www.example.com’,20230201,3,120,1], . . . ), and so on. Example AI outputs include proposal point ‘Product A matches past purchase trends,’ relevance score 0.92, and so on. In subsequent processing, proposal points with high relevance scores are preferentially displayed, and detailed purchase and browsing history are supplementally displayed in tooltips or subpanels. The display unit is designed so that contract history, purchase history, and browsing history can be switched and displayed in tabs or drill-down format on the user interface, allowing operators to instantly refer to optimal supporting information for each customer. As a technical effect, by integrally displaying not only contract history but also purchase and browsing history, the display unit can communicate the customer's latent needs and interests with high accuracy. This enables improvements in cross-selling and up-selling accuracy, proposal comprehensiveness, and customer satisfaction, which were difficult with conventional simple history referencing, thereby achieving essential improvements in computer technology. Application fields include e-commerce site recommendation engines, financial and insurance product proposals, subscription service retention improvement measures, and any domain requiring comprehensive customer behavior analysis.

The display unit can display, when presenting proposal points, the popularity of products and market trends. For example, the display unit collects product popularity data and reflects it in the proposal points. The display unit may also analyze market trend information and reflect it in the proposal points. Additionally, the display unit can combine product popularity and market trends to display the most suitable proposal points. By displaying product popularity and market trends, more appropriate proposal points can be provided. Some or all of the above-described processes in the display unit may be performed using AI or without using AI. For example, the display unit may input product popularity data into a generative AI and have the generative AI perform popularity analysis. Specifically, the display unit collects sales performance data for each product (e.g., product ID, number of sales, sales period, repeat rate, campaign response rate, etc.) and market trend data (e.g., search volume, number of SNS posts, frequency of industry news, seasonality indicators, etc.). These data are vectorized, generating feature vectors (e.g., 20 dimensions) for each product and inputting them into the AI model. The AI model uses time-series RNN or graph neural networks to analyze popularity trends and market trend changes, outputting, for each proposal point, a ‘market suitability score’ (e.g., continuous value from 0.0 to 1.0) and trend rise prediction (e.g., ‘yes’ or ‘no’). Example AI inputs include product ID ‘101,’ number of sales ‘5,000,’ search volume ‘20,000,’ number of SNS posts ‘1,500,’ and so on. Example AI outputs include market suitability score ‘0.92,’ trend rise prediction ‘yes,’ and so on. In subsequent processing, products with high scores or rising trends are emphasized as proposal points, and popularity trends and trend changes are visualized with graphs and charts. The display unit is designed to allow interactive display of product popularity graphs and market trend charts for each product on the user interface, enabling operators to make persuasive proposals based on market trends. As a technical effect, the display unit analyzes and visualizes product popularity and market trends as high-dimensional data using AI, enabling rapid response to market changes and proposal accuracy improvement based on demand forecasting, which were difficult with conventional simple sales performance referencing. This achieves essential improvements in computer technology, such as optimizing proposal timing, increasing product acquisition rates, and improving marketing efficiency. Application fields include new product proposals in telecommunications, insurance, and retail, e-commerce site trend recommendations, B2B sales market analysis support, and any proposal operations utilizing market trends.

The display unit can estimate the customer's emotions and adjust the priorities of the display contents based on the estimated emotions. For example, if the customer is feeling stressed, the display unit simplifies the display contents to reduce visual burden. If the customer is relaxed, the display unit provides display contents that include detailed information. Additionally, if the customer is excited, the display unit adjusts the display contents using visually appealing graphs and charts. By adjusting the priorities of the display contents according to the customer's emotions, the display can be made easier for the customer to understand. Emotion estimation is realized using, for example, an emotion engine or generative AI with emotion estimation functions. Generative AI may include text generation AI (e.g., LLM) or multimodal generative AI, but is not limited to these examples. Some or all of the above-described processes in the display unit may be performed using AI or without using AI. For example, the display unit may input customer emotion data into a generative AI and have the generative AI perform emotion estimation. Specifically, the display unit accepts multimodal data for customer emotion estimation, such as voice data (e.g., conversational audio waveform data, 16 kHz sampling, 30 seconds), text data (e.g., chat history, 500 tokens), and facial images (e.g., face images 128×128 pixels). The display unit preprocesses these data (voice feature extraction, facial landmark detection, morphological analysis of text) and inputs them into a multimodal neural network for emotion estimation (voice: CNN+RNN, image: CNN, text: Transformer). The AI model outputs probability distributions for each emotion category (e.g., stress 0.7, relaxation 0.2, excitement 0.1). The display unit selects the emotion category with the highest probability and transmits it to the display priority adjustment module. For example, if stress is high, only highly important information is displayed at the top; if relaxed, detailed and supplementary information is displayed in multiple layers; if excited, interactive graphs and charts are used for visual emphasis. Example AI inputs include audio waveform data, chat text such as ‘I am satisfied with my recent contract,’ and facial image data. Example AI outputs include emotion category ‘stress’ probability 0.8, ‘relaxation’ probability 0.1, ‘excitement’ probability 0.1, and so on. In subsequent processing, the GUI display layout, information hierarchy, color scheme, and amount of information are dynamically switched according to the emotion category. The display unit applies different templates and styles to the rendering engine for each emotion category to realize information prioritization and automatic switching of display modes according to emotional state on the user interface. As a technical effect, the display unit optimizes the priorities of the display contents according to the customer's emotional state, thereby improving the customer's understanding and acceptance and enhancing information transmission efficiency. It can flexibly respond to diverse customer states that could not be addressed by conventional uniform displays, improving the quality of customer experience. Application fields include call center support, online customer service, medical consultations, personalized learning support in education, and any scene where information presentation according to emotional state is required.

The display unit can take into account the customer's geographic location information when displaying proposal points. For example, the display unit collects the customer's residential information and reflects it in the display of proposal points. The display unit may also analyze the customer's movement history and reflect it in the display of proposal points. Additionally, the display unit can display region-specific proposal points based on the customer's geographic location information. By considering the customer's geographic location information, region-specific proposal points can be displayed. Some or all of the above-described processes in the display unit may be performed using AI or without using AI. For example, the display unit may input the customer's geographic location information data into a generative AI and have the generative AI perform geographic location information analysis. Specifically, the display unit collects the customer's residential information (e.g., prefecture, city/ward/town/village, postal code as categorical data) and movement history (e.g., GPS coordinates, movement date and time, movement distance, destination category as time-series data). These data are vectorized, with residential information as one-hot encoding and movement history as a time-series tensor (e.g., up to 365 items, each with 5 dimensions), and input into the AI model. The display unit uses a neural network for geographic feature extraction (e.g., time-series RNN+geographic clustering layer) to analyze correlations between contract history and geographic information. The AI model outputs, for each proposal point, region suitability scores (e.g., urban area 0.85, suburban area 0.60, rural area 0.30) and product demand forecasts based on movement patterns (e.g., increased insurance demand within commuting areas). Example AI inputs include residential information ‘Shinjuku-ku, Tokyo,’ movement history tensor (e.g., [[35.6895,139.6917,20230101,5.2,1], . . . ]), and so on. Example AI outputs include region category ‘urban area’ contract tendency 0.85, movement pattern ‘commuting type’ demand forecast 0.75, and so on. In subsequent processing, proposal points corresponding to regional contract tendencies and movement patterns are emphasized and visualized as heat maps or region-specific rankings on a map. The display unit is designed to allow region-specific proposal points to be displayed in a map-linked format on the user interface, enabling operators to make targeting proposals based on regional characteristics. As a technical effect, the display unit analyzes and visualizes geographic location information as high-dimensional data using AI, enabling precise understanding of regional characteristics and demand forecasting based on movement patterns, which were difficult with conventional simple residential information referencing. This achieves essential improvements in computer technology, such as region-optimized proposals, advanced product placement strategies, and improved marketing efficiency for each region. Application fields include region-specific proposals in telecommunications, insurance, and retail, tourism targeting, urban planning support, and any proposal operations utilizing geographic information.

The display unit can analyze the customer's social media activities and display relevant information when presenting proposal points. For example, the display unit collects the customer's social media posts and reflects them in the display of proposal points. The display unit may also analyze the customer's interests and concerns on social media and reflect them in the display of proposal points. Additionally, the display unit can analyze the frequency of the customer's social media activities and reflect this in the display of proposal points. By analyzing the customer's social media activities, proposal points can be provided based on the customer's interests and concerns. Some or all of the above-described processes in the display unit may be performed using AI or without using AI. For example, the display unit may input the customer's social media data into a generative AI and have the generative AI perform the analysis of social media activities. Specifically, the display unit collects data for analyzing the customer's social media activities, such as post text data (e.g., up to 1,000 posts, each post up to 512 tokens of natural language text), post timestamps, images associated with posts (e.g., 128×128 pixel images), and engagement metrics such as ‘likes’ and ‘shares’ (e.g., the number of reactions quantified for each post). As preprocessing, the display unit performs morphological analysis and tokenization for text, face detection and object recognition for images, and normalization for engagement, generating feature vectors for each post (e.g., text embedding vectors, image feature vectors, engagement scores). These features are input to the AI model as a time-series tensor (e.g., 1,000 posts×50 dimensions). The display unit uses a Transformer-based multimodal neural network to analyze the correlations among post content, images, and engagement in a high-dimensional space, outputting interest category scores and relevance scores for each proposal point. For example, the AI model may output scores such as ‘Product A: 0.82, Product B: 0.65, Product C: 0.40.’ Furthermore, the AI model extracts changes in customer interests and trends from time-series patterns of posting frequency and engagement. Example AI inputs include post text such as ‘I bought a new smartwatch,’ post image data, and engagement scores such as ‘likes: 25, shares: 3.’ Example AI outputs include proposal point ‘Home appliance category relevance 0.90,’ posting frequency trend ‘increasing,’ and so on. In subsequent processing, the extracted interest categories and trend information are integrated with contract history data for personalization of proposal points and excerpt display of related posts. The display unit is designed to allow proposal points based on social media activities to be displayed on the user interface as timelines, tag clouds, or with related images, enabling operators to make proposals based on the customer's latest interests and concerns. As a technical effect, the display unit can extract and visualize real-time changes in customer interests, concerns, and lifestyle with high accuracy, which could not be captured by conventional contract or purchase history alone. This greatly improves the degree of personalization of proposals, increases product acquisition rates and customer satisfaction, and enhances the accuracy of cross-selling and up-selling, thereby achieving essential improvements in computer technology. Application fields include proposal operations utilizing social media activities, such as telecommunications services, insurance and financial product proposals, e-commerce site recommendation engines, B2B sales support, and personalized ad delivery.

The system according to the embodiment is not limited to the examples described above and can be variously modified, for example, as follows. Specifically, the system can adopt multiple variations and extension methods for the module configuration of the analysis unit, specifying unit, prioritization unit, and display unit, as well as the architecture of AI models, data flow, input/output specifications, learning methods, parameter settings, data augmentation techniques, and post-processing logic. The system can flexibly change the overall operational form, such as linking multiple AI models (e.g., Transformer for contract history analysis, multimodal network for emotion estimation, time-series RNN for purchase prediction, graph neural network for trend analysis), parallel inference processing in distributed cloud environments, lightweight model inference on edge devices, real-time data stream analysis, and batch processing for bulk analysis. Furthermore, technical improvements can be multilayered, including the introduction of transfer learning and self-supervised learning, data augmentation (e.g., synthetic history generation, noise addition, time-series shuffling), ensemble inference, and the addition of anomaly detection modules, as well as the design of learning datasets, feature engineering, loss functions, and weight optimization algorithms (e.g., Adam, RMSProp, LAMB). Regarding input/output data, diverse data sources such as contract history, purchase history, browsing history, geographic information, emotion data, social media activities, health data, feedback, reviews, family structure, occupation, lifestyle, travel history, seasonality data, etc., can be integrated, and the dimensions and structure of input tensors and feature vectors for AI models can be dynamically expanded. In post-processing, various branching and linkage are possible according to business requirements and operational environments, such as threshold judgment, ranking, personalized notifications, recording in history databases, visualization on dashboards, and information sharing with external systems via API integration. As a technical effect, by allowing diverse variations in AI models, data flow, operational forms, input/output specifications, and post-processing logic, the system enables optimal system design and operation according to industry, business type, operational scale, and data characteristics, achieving essential improvements in computer technology such as flexibility, scalability, operational efficiency, accuracy, real-time capability, and degree of personalization, which were difficult to realize with conventional uniform system configurations. Application fields include telecommunications, insurance, finance, retail, healthcare, education, tourism, government, B2B sales, e-commerce, ad delivery, and any customer data analysis and proposal operations.

The analysis unit can analyze, in addition to the customer's past contract history, the customer's health data. For example, the analysis unit analyzes data collected from the customer's fitness tracker or smartwatch and combines it with contract history to understand the customer's health status. This enables more appropriate product proposals based on the customer's health status. The analysis unit can also prioritize proposals for products related to health using the customer's health data. For example, if the customer is interested in health, health foods or fitness-related products can be preferentially proposed. This enables proposals tailored to the customer's health status, which is expected to improve customer satisfaction. Specifically, the analysis unit collects vital data for each customer, such as steps, heart rate, sleep time, calories burned, exercise intensity, weight, blood pressure, and blood oxygen concentration, as daily or minute-level time-series tensors (e.g., 365 days×10 dimensions). The analysis unit preprocesses these health data (e.g., missing value imputation, outlier removal, normalization, moving average) and concatenates them with contract history data (e.g., contract ID, contract start date, contract amount, contract category as structured data) for input into the AI model. The AI model may use RNN or Transformer specialized for extracting time-series patterns in health data, or a multimodal neural network for analyzing correlations between health status and contract history. Example AI inputs include step data (e.g., 8,000 steps per day), heart rate (e.g., average 72 bpm), sleep time (e.g., 7.5 hours), contract history tensor (e.g., [[1,20220101,10000, health insurance], . . . ]), and so on. The AI model outputs health status scores (e.g., 0.85), health risk predictions (e.g., hypertension risk 0.12), and interest scores for each health category (e.g., fitness 0.90, health foods 0.75). Furthermore, the AI model extracts trends in health status changes (e.g., increasing exercise, sleep deprivation) and, from the combination of health status and contract history, estimates future needs for health-related products (e.g., fitness gym contract recommendation score 0.88, supplement recommendation score 0.65). In subsequent processing, only products with high health status scores or recommendation scores are extracted as proposal candidates and transmitted to the prioritization unit or display unit. As a technical effect, by integrating and analyzing high-frequency, high-dimensional time-series health data with AI, the analysis unit enables real-time understanding of customer health status, health risk prediction, and personalized health product proposals, which were difficult with conventional simple contract history referencing. This achieves essential improvements in computer technology, such as improved proposal accuracy, support for health maintenance and promotion, reduction of medical expenses, and increased customer satisfaction. Application fields include personalized proposals for insurance, healthcare, fitness, and wellness services, health management support for employees, and recommendation engines for healthcare apps, and any proposal operations utilizing health data.

The analysis unit can estimate the customer's emotions and analyze the customer's preferences and tastes based on the estimated emotions. For example, if the customer is happy, the analysis unit preferentially proposes products that the customer has liked in the past. If the customer is sad, products to lift the mood are proposed. Additionally, if the customer is excited, products to maintain excitement can also be proposed. This enables proposals tailored to the customer's emotions, thereby increasing customer satisfaction. Emotion estimation is realized using, for example, an emotion engine or generative AI with emotion estimation functions. The analysis unit may input customer emotion data into a generative AI and have the generative AI perform emotion estimation. Specifically, the analysis unit accepts multimodal data for customer emotion estimation, such as voice data (e.g., conversational audio waveform data, 16 kHz sampling, 30 seconds), text data (e.g., chat history, 500 tokens), and facial images (e.g., face images 128×128 pixels). The analysis unit preprocesses these data (voice feature extraction, facial landmark detection, morphological analysis of text) and inputs them into a multimodal neural network for emotion estimation (voice: CNN+RNN, image: CNN, text: Transformer). The AI model outputs probability distributions for each emotion category (e.g., joy 0.7, sadness 0.1, excitement 0.2). The analysis unit selects the emotion category with the highest probability and transmits it to the preference/taste analysis module. The preference/taste analysis module vectorizes diverse data such as the customer's past purchase history, browsing history, feedback, reviews, and social media activities, and inputs them into the AI model in combination with the emotional state. The AI model scores optimal product categories and proposal contents for each emotional state, outputting proposal candidate lists such as ‘prioritize highly rated products during joy, prioritize relaxation products during sadness, prioritize entertainment/active products during excitement.’ Example AI inputs include audio waveform data, chat text such as ‘I am very happy today,’ facial image data, and past purchase history tensor. Example AI outputs include emotion category ‘joy’ probability 0.7, proposal candidate ‘entertainment product’ score 0.85, ‘relaxation product’ score 0.30, and so on. In subsequent processing, proposal contents are dynamically generated by combining the emotion category and top-scoring products, and transmitted to the prioritization unit or display unit. As a technical effect, by integrating and analyzing emotional states and preference data in a high-dimensional space, the analysis unit enables personalized proposals tailored to the customer's psychological state, which were difficult with conventional uniform proposals. This greatly improves the persuasiveness, acceptability, and satisfaction of proposals, as well as the quality of customer experience and product acquisition rates, thereby achieving essential improvements in computer technology. Application fields include e-commerce site recommendation engines, customer support, online customer service, personalized proposals in education, healthcare, and entertainment, and any proposal operations utilizing emotions and preferences.

The analysis unit can analyze, in addition to the customer's past contract history, data related to the customer's hobbies and lifestyle. For example, the analysis unit collects information about the customer's hobbies and lifestyle activities and analyzes it in combination with contract history. This enables more appropriate product proposals based on the customer's hobbies and lifestyle. The analysis unit can also prioritize proposals for products related to the customer's hobbies and lifestyle. For example, if the customer enjoys outdoor activities, outdoor goods and related products can be preferentially proposed. This enables proposals tailored to the customer's hobbies and lifestyle, which is expected to improve customer satisfaction. Specifically, the analysis unit collects hobby and lifestyle data for each customer, such as hobby categories (e.g., outdoor, music, cooking, sports, reading), activity frequency (e.g., three times a week), activity history (e.g., event participation dates, related product purchase dates), and lifestyle attributes (e.g., morning/evening type, car ownership, pet ownership, dietary habits). These data are vectorized, with categorical variables as one-hot encoding, activity history as time-series tensors (e.g., 365 days×10 dimensions), and lifestyle attributes as feature vectors (e.g., 20 dimensions), and concatenated with contract history data for input into the AI model. The AI model may use a multimodal neural network for hobby/lifestyle feature extraction or a Transformer for estimating product relevance for each hobby category. Example AI inputs include hobby category ‘outdoor,’ activity frequency ‘twice a week,’ lifestyle attributes ‘morning type, pet owner,’ and contract history tensor. The AI model outputs product suitability scores for each hobby/lifestyle (e.g., outdoor goods 0.92, pet-related 0.75, cooking goods 0.30) and proposal priority based on activity trends (e.g., weekend product recommendation score 0.80). Furthermore, the AI model extracts trends in hobby/lifestyle changes (e.g., starting a new hobby, increasing activity frequency) and estimates future needs and cross-sell candidates. In subsequent processing, products with high scores or newly predicted needs are extracted as proposal candidates and transmitted to the prioritization unit or display unit. As a technical effect, by integrating and analyzing diverse and high-dimensional attribute data such as hobbies and lifestyle with AI, the analysis unit enables understanding of the customer's actual lifestyle and latent needs, and personalized product proposals, which were difficult with conventional contract history referencing. This achieves essential improvements in computer technology, such as improved proposal accuracy, increased customer satisfaction, and more efficient cross-selling and up-selling. Application fields include personalized recommendations for e-commerce sites, hobby/lifestyle-specialized services, and targeting proposals for insurance, finance, and retail, and any proposal operations utilizing hobby/lifestyle data.

The analysis unit can take into account the customer's family structure and life stage when analyzing the customer's contract history. For example, the analysis unit collects the customer's family structure data and analyzes it in combination with contract history. This enables more appropriate product proposals based on the customer's family structure. The analysis unit can also prioritize proposals for products according to the customer's life stage. For example, if the customer is newly married, household goods and products necessary for a new life can be preferentially proposed. This enables proposals tailored to the customer's family structure and life stage, which is expected to improve customer satisfaction. Specifically, the analysis unit collects family structure data for each customer, such as number of family members, presence of spouse, presence and age of children, attributes of cohabiting family members (e.g., elderly, pets), and life stage (e.g., single, newly married, child-rearing, senior). These data are vectorized, with categorical variables as one-hot encoding, number of family members and ages as numerical vectors, and life stage as time-series tensors (e.g., 10 years×5 dimensions), and concatenated with contract history data for input into the AI model. The AI model may use a multimodal neural network for family structure/life stage feature extraction or a time-series RNN for life event prediction. Example AI inputs include number of family members ‘4,’ presence of spouse ‘yes,’ child age ‘5,’ life stage ‘newly married,’ and contract history tensor. The AI model outputs product suitability scores for each family structure/life stage (e.g., household goods 0.90, education-related 0.75, senior-oriented 0.30) and proposal priority based on future life event predictions (e.g., expected childbirth, expected child advancement). Furthermore, the AI model extracts trends in family structure and life stage changes (e.g., child growth, increase in family members) and estimates future needs and cross-sell candidates. In subsequent processing, products with high scores or those based on life event predictions are extracted as proposal candidates and transmitted to the prioritization unit or display unit. As a technical effect, by integrating and analyzing diverse and high-dimensional attribute data such as family structure and life stage with AI, the analysis unit enables understanding of the customer's actual lifestyle and future needs, and personalized product proposals, which were difficult with conventional contract history referencing. This achieves essential improvements in computer technology, such as improved proposal accuracy, increased customer satisfaction, and more efficient cross-selling and up-selling. Application fields include life stage-specific proposals for insurance, finance, and retail, targeting proposals for education, housing, and medical services, and any proposal operations utilizing family structure and life stage data.

The analysis unit can estimate the customer's emotions and analyze the customer's stress level based on the estimated emotions. For example, if the customer is experiencing high stress, the analysis unit proposes products with relaxation effects. If the customer is experiencing low stress, active products are proposed. Additionally, if the customer is experiencing moderate stress, balanced products can also be proposed. This enables proposals tailored to the customer's stress level, thereby improving the customer's health and satisfaction. Emotion estimation is realized using, for example, an emotion engine or generative AI with emotion estimation functions. The analysis unit may input customer emotion data into a generative AI and have the generative AI perform emotion estimation. Specifically, the analysis unit accepts multimodal data for customer stress estimation, such as voice data (e.g., conversational audio waveform data, 16 kHz sampling, 30 seconds), text data (e.g., chat history, 500 tokens), facial images (e.g., face images 128×128 pixels), and biometric sensor data (e.g., skin conductance, heart rate variability). The analysis unit preprocesses these data (voice feature extraction, facial landmark detection, morphological analysis of text, spectral analysis of biometric signals) and inputs them into a multimodal neural network for stress estimation (voice: CNN+RNN, image: CNN, text: Transformer, biometric signals: 1D-CNN). The AI model outputs probability distributions and stress scores for each stress level (e.g., high 0.6, moderate 0.3, low 0.1; stress score 0.78). The analysis unit selects the stress level with the highest probability and transmits it to the product proposal module according to stress level. The product proposal module preferentially proposes relaxation products (e.g., aroma, massage devices, healing music) for high stress, active products (e.g., sports goods, outdoor gear) for low stress, and balanced products (e.g., health foods, light exercise goods) for moderate stress. Example AI inputs include audio waveform data, chat text such as ‘I've been feeling tired lately,’ facial image data, and biometric sensor data. Example AI outputs include stress level ‘high’ probability 0.7, relaxation product score 0.85, active product score 0.20, and so on. In subsequent processing, proposal contents are generated by combining the stress level and top-scoring products and transmitted to the prioritization unit or display unit. As a technical effect, by integrating and analyzing emotional, biometric, and behavioral data in a high-dimensional space, the analysis unit enables personalized proposals tailored to the customer's psychological and health state, which were difficult with conventional subjective stress evaluation or uniform proposals. This achieves essential improvements in computer technology, such as health maintenance and promotion, increased satisfaction, and reduced stress-related risks. Application fields include health management support, wellness services, stress care product proposals, and personalized proposals in medical, educational, and customer support fields, and any proposal operations utilizing stress state.

The analysis unit can take into account the customer's occupation and work status when analyzing the customer's contract history. For example, the analysis unit collects the customer's occupation data and analyzes it in combination with contract history. This enables more appropriate product proposals based on the customer's occupation. The analysis unit can also prioritize proposals for products according to the customer's work status. For example, if the customer is working remotely, products related to remote work can be preferentially proposed. This enables proposals tailored to the customer's occupation and work status, which is expected to improve customer satisfaction. Specifically, the analysis unit collects occupation data for each customer, such as job type (e.g., IT engineer, sales, healthcare worker, educator), industry, position, work style (e.g., full-time, part-time, remote work, shift work), working hours, commuting status, and workplace location. These data are vectorized, with categorical variables as one-hot encoding, working hours and commuting distance as numerical vectors, and work history as time-series tensors (e.g., 365 days×5 dimensions), and concatenated with contract history data for input into the AI model. The AI model may use a multimodal neural network for occupation/work status feature extraction or a Transformer for estimating product relevance for each work style. Example AI inputs include job type ‘IT engineer,’ work style ‘remote work,’ working hours ‘9-18,’ and contract history tensor. The AI model outputs product suitability scores for each occupation/work status (e.g., remote work-related 0.88, commuting goods 0.30, office supplies 0.75) and proposal priority based on work style (e.g., product recommendation score for telecommuters 0.90). Furthermore, the AI model extracts trends in work status changes (e.g., transition to remote work, change in working hours) and estimates future needs and cross-sell candidates. In subsequent processing, products with high scores or those based on work status changes are extracted as proposal candidates and transmitted to the prioritization unit or display unit. As a technical effect, by integrating and analyzing diverse and high-dimensional attribute data such as occupation and work status with AI, the analysis unit enables understanding of the customer's actual occupation and work style, and personalized product proposals, which were difficult with conventional contract history referencing. This achieves essential improvements in computer technology, such as improved proposal accuracy, increased customer satisfaction, and more efficient cross-selling and up-selling. Application fields include occupation-specific proposals for office, IT, education, healthcare, and retail, remote work support services, and work style change-adaptive recommendations, and any proposal operations utilizing occupation and work status data.

The analysis unit can take into account the customer's travel history and travel preferences when analyzing the customer's contract history. For example, the analysis unit collects the customer's past travel history and analyzes it in combination with contract history. This enables more appropriate product proposals based on the customer's travel preferences. The analysis unit can also prioritize proposals for products according to the customer's travel history. For example, if the customer travels frequently, travel-related products can be preferentially proposed. This enables proposals tailored to the customer's travel history and preferences, which is expected to improve customer satisfaction. Specifically, the analysis unit collects travel history data for each customer, such as travel destinations (e.g., domestic/overseas, city names), travel schedules, travel frequency, travel purposes (e.g., sightseeing, business, homecoming), companion attributes (e.g., family, friends, solo), travel means (e.g., airplane, train, car), and purchase history during travel (e.g., local purchases, accommodation usage). These data are vectorized, with categorical variables as one-hot encoding, travel schedules and frequency as numerical vectors, and travel history as time-series tensors (e.g., 10 years×15 dimensions), and concatenated with contract history data for input into the AI model. The AI model may use a multimodal neural network for travel history/preference feature extraction or a Transformer for estimating product relevance for each travel category. Example AI inputs include travel destination ‘Okinawa,’ travel frequency ‘three times a year,’ travel purpose ‘sightseeing,’ and contract history tensor. The AI model outputs product suitability scores for each travel history/preference (e.g., travel insurance 0.95, local experience products 0.80, travel goods 0.70) and proposal priority based on travel trends (e.g., product recommendation score for overseas travelers 0.85). Furthermore, the AI model extracts trends in travel history changes (e.g., increase in overseas travel, increase in family travel) and estimates future needs and cross-sell candidates. In subsequent processing, products with high scores or those based on travel trends are extracted as proposal candidates and transmitted to the prioritization unit or display unit. As a technical effect, by integrating and analyzing diverse and high-dimensional attribute data such as travel history and preferences with AI, the analysis unit enables understanding of the customer's actual travel behavior and latent needs, and personalized product proposals, which were difficult with conventional contract history referencing. This achieves essential improvements in computer technology, such as improved proposal accuracy, increased customer satisfaction, and more efficient cross-selling and up-selling. Application fields include traveler-oriented proposals for travel, tourism, insurance, and retail, travel recommendation engines, and travel history-based marketing, and any proposal operations utilizing travel history and preference data.

The specifying unit can estimate the customer's emotions and analyze the customer's purchase intent based on the estimated emotions. For example, if the customer shows high purchase intent, the specifying unit makes aggressive proposals. If the customer shows low purchase intent, the specifying unit makes reserved proposals. Additionally, if the customer shows moderate purchase intent, the specifying unit can make balanced proposals. This enables proposals tailored to the customer's purchase intent, thereby increasing customer satisfaction. Emotion estimation is realized using, for example, an emotion engine or generative AI with emotion estimation functions. The specifying unit may input customer emotion data into a generative AI and have the generative AI perform emotion estimation. Specifically, the specifying unit accepts multimodal data for customer purchase intent estimation, such as voice data (e.g., conversational audio waveform data, 16 kHz sampling, 30 seconds), text data (e.g., chat history, 500 tokens), facial images (e.g., face images 128×128 pixels), and purchase behavior logs (e.g., number of times items added to cart, time spent on product pages). The specifying unit preprocesses these data (voice feature extraction, facial landmark detection, morphological analysis of text, normalization of behavior logs) and inputs them into a multimodal neural network for purchase intent estimation (voice: CNN+RNN, image: CNN, text: Transformer, behavior logs: time-series RNN). The AI model outputs probability distributions and purchase intent scores for each purchase intent level (e.g., high 0.6, moderate 0.3, low 0.1; purchase intent score 0.78). The specifying unit selects the purchase intent level with the highest probability and transmits it to the proposal module according to purchase intent. The proposal module generates aggressive cross-sell/up-sell proposals for high purchase intent, reserved or informational proposals for low purchase intent, and balanced proposals for moderate purchase intent. Example AI inputs include audio waveform data, chat text such as ‘I'm interested in this product,’ facial image data, and number of times items added to cart ‘5.’ Example AI outputs include purchase intent level ‘high’ probability 0.7, aggressive proposal score 0.85, reserved proposal score 0.20, and so on. In subsequent processing, proposal contents are generated by combining the purchase intent level and top-scoring proposals and transmitted to the prioritization unit or display unit. As a technical effect, by integrating and analyzing emotional and behavioral data in a high-dimensional space, the specifying unit enables personalized proposals tailored to the customer's psychological state and purchase intent, which were difficult with conventional subjective purchase intent evaluation or uniform proposals. This achieves essential improvements in computer technology, such as improved proposal acceptance and conversion rates, increased customer satisfaction, and more efficient cross-selling and up-selling. Application fields include purchase intent estimation-based recommendations for e-commerce sites, customer support, online customer service, and personalized proposals for finance, insurance, and retail, and any proposal operations utilizing purchase intent data.

The specifying unit can take into account the customer's feedback and reviews, in addition to the customer's past contract history, when identifying uncontracted products. For example, the specifying unit collects feedback and reviews provided by the customer in the past and analyzes them in combination with contract history to identify uncontracted products. This enables more appropriate product proposals based on the customer's feedback and reviews. The specifying unit can also prioritize proposals for products according to the customer's feedback and reviews. For example, products related to those highly rated by the customer can be preferentially proposed. This enables proposals tailored to the customer's feedback and reviews, which is expected to improve customer satisfaction. Specifically, the specifying unit collects feedback and reviews for each customer, such as product ratings (e.g., 1 to 5 points), review text (e.g., up to 512 tokens), review posting date, feedback type (e.g., satisfaction, dissatisfaction, request), and engagement with reviews (e.g., number of likes, number of replies). These data are preprocessed (morphological analysis and tokenization of text, normalization of ratings, scoring of engagement), and feature vectors are generated for each review (e.g., text embedding vector, rating, engagement score), which are concatenated with contract history data for input into the AI model. The AI model may use a Transformer-based multimodal neural network for correlation analysis of review content, ratings, and contract history. Example AI inputs include review text such as ‘This insurance was very helpful,’ rating ‘5,’ engagement ‘likes: 10,’ and contract history tensor. The AI model outputs product relevance scores for each review/feedback (e.g., related product A 0.92, B 0.75, C 0.30) and proposal priority based on review trends (e.g., recommendation score for products related to highly rated items 0.85). Furthermore, the AI model extracts trends in review content changes (e.g., increasing satisfaction, increasing requests) and estimates future needs and cross-sell candidates. In subsequent processing, products with high scores or those based on review trends are extracted as proposal candidates and transmitted to the prioritization unit or display unit. As a technical effect, by integrating and analyzing subjective and high-dimensional text and rating data such as reviews and feedback with AI, the specifying unit enables understanding of customer satisfaction, requests, and latent needs, and personalized product proposals, which were difficult with conventional contract history referencing. This achieves essential improvements in computer technology, such as improved proposal accuracy, increased customer satisfaction, and more efficient cross-selling and up-selling. Application fields include review-based recommendation engines for e-commerce sites, customer support, and feedback analysis-based proposals for finance, insurance, and retail, and any proposal operations utilizing review and feedback data.

The specifying unit can take into account product seasonality, in addition to product popularity and market trends, when identifying uncontracted products. For example, the specifying unit collects product seasonality data and uses it to identify uncontracted products. This enables proposals for products according to the season. The specifying unit can also prioritize proposals for products related to seasonality. For example, in summer, cooling goods and outdoor products can be preferentially proposed, and in winter, heating appliances and cold-weather goods can be preferentially proposed. This enables proposals that take product seasonality into account, which is expected to improve customer satisfaction. Specifically, the specifying unit collects seasonality data for each product, such as monthly sales trends (e.g., 12 months×number of sales), seasonal events (e.g., summer sales, winter campaigns), weather data (e.g., temperature, precipitation), and market trend data (e.g., search volume, number of SNS posts). These data are vectorized as time-series tensors (e.g., 12 months×10 dimensions), event flags, and weather data vectors, and concatenated with product feature vectors for input into the AI model. The AI model may use time-series RNN or graph neural networks for correlation analysis of seasonality, trends, and weather data. Example AI inputs include product ID ‘201,’ monthly sales numbers ‘January: 100, July: 500,’ temperature ‘July: 30° C.,’ event ‘summer sale,’ and so on. The AI model outputs season suitability scores for each product (e.g., summer 0.92, winter 0.30), trend rise prediction (e.g., ‘yes’), and demand forecast (e.g., July demand 0.85). Furthermore, the AI model extracts products expected to have increased demand in the future based on combinations of seasonality, trend, and weather data. In subsequent processing, products with high season suitability or demand forecast are preferentially extracted as proposal candidates and used to optimize proposal contents. As a technical effect, by integrating and analyzing high-dimensional time-series data such as seasonality, weather, and trends with AI, the specifying unit enables rapid response to seasonal and weather changes and proposal accuracy improvement based on demand forecasting, which were difficult with conventional simple sales performance referencing. This achieves essential improvements in computer technology, such as optimizing proposal timing, increasing product acquisition rates, and improving marketing efficiency. Application fields include seasonal proposals for telecommunications, insurance, and retail, seasonal trend recommendations for e-commerce sites, B2B sales support for seasonal demand analysis, and any proposal operations utilizing seasonality and weather data.

The following is a brief explanation of the processing flow of Example of the Embodiment. Specifically, the system realizes a series of processes from customer data analysis to proposal display through cooperation among multiple AI models and modules. First, the analysis unit collects and vectorizes diverse data sources such as contract history, purchase history, browsing history, health data, emotion data, geographic information, social media activities, family structure, occupation, lifestyle, travel history, feedback, reviews, and seasonality data, and inputs each data as time-series tensors or feature vectors into AI models. The analysis unit uses time-series RNN, Transformer, and multimodal neural networks to analyze customer needs, interests, health status, emotional state, life events, regional characteristics, hobbies, occupation, travel trends, and review trends in a high-dimensional space, obtaining outputs such as scores, labels, probability distributions, and trend predictions. The specifying unit receives the output results from the analysis unit and uses AI models to calculate relevance scores, market suitability, season suitability, demand forecasts, etc., for each uncontracted product candidate, generating a proposal candidate list. The prioritization unit executes a prioritization algorithm using AI, considering customer emotions, purchase intent, health status, regional characteristics, market trends, etc., for the proposal candidates from the specifying unit, and determines the optimal proposal order. The display unit dynamically visualizes proposal points, supporting information, graphs, charts, heat maps, etc., according to the output from the prioritization unit and the customer's emotional state and device characteristics. Each step is clearly designed with examples of AI model inputs and outputs (e.g., health data tensor→health status score, emotion data→emotion category probability distribution, contract history tensor→contract continuation prediction) and post-processing (threshold judgment, ranking, personalized notification, dashboard recording, etc.). As a technical effect, the system can realize high-precision and high-efficiency personalized proposals that respond to diverse customer states, behaviors, and environmental changes, which were difficult with conventional simple history referencing or rule-based processing. This achieves essential improvements in computer technology, such as improved proposal accuracy, customer satisfaction, business efficiency, cross-sell and up-sell rates, and LTV. Application fields include telecommunications, insurance, finance, retail, healthcare, education, tourism, government, B2B sales, e-commerce, ad delivery, and any customer data analysis and proposal operations.

Step 1: The analysis unit analyzes the customer's past contract history. The customer's past contract history includes contract type, contract period, contract amount, and so on. The analysis unit collects the customer's contract history data and uses AI to analyze it, thereby understanding the customer's needs and interests. Step 2: The specifying unit identifies uncontracted products based on the data analyzed by the analysis unit. Uncontracted products include products in specific categories or products not contracted within a specific period. The specifying unit uses AI to identify uncontracted products based on the data analyzed by the analysis unit. Step 3: The prioritization unit assigns proposal priorities to the uncontracted products identified by the specifying unit. Proposal priorities include the customer's needs and the importance of the products. The prioritization unit uses AI to assign proposal priorities to the uncontracted products identified by the specifying unit. Step 4: The display unit displays proposal points for the products prioritized by the prioritization unit. Proposal points include the main points of the proposal, benefits, price, and so on. The display unit displays proposal points for the products prioritized by the prioritization unit. Specifically, in Step 1, the system inputs contract history data (e.g., contract ID, contract start date, contract end date, contract amount, contract category, etc., as a time-series tensor of up to 100 items×10 dimensions) into an AI model (e.g., time-series RNN or Transformer) and outputs contract continuation tendency scores, contract renewal probabilities, cancellation risks, and so on. In Step 2, the specifying unit integrates the output from the analysis unit (e.g., contract continuation score 0.85, interest category score 0.90, etc.) with purchase history, browsing history, health data, geographic information, social media activities, reviews, seasonality data, etc., and uses AI models to calculate relevance scores, market suitability, season suitability, demand forecasts, etc., for each uncontracted product candidate. In Step 3, the prioritization unit executes a prioritization algorithm using AI, considering customer emotions, purchase intent, health status, regional characteristics, market trends, etc., for the proposal candidates from the specifying unit, and determines the optimal proposal order. In Step 4, the display unit dynamically visualizes proposal points, supporting information, graphs, charts, heat maps, etc., according to the output from the prioritization unit and the customer's emotional state and device characteristics. Each step is clearly designed with examples of AI model inputs and outputs (e.g., contract history tensor→contract continuation prediction, purchase history tensor→relevance score, emotion data →emotion category probability distribution) and post-processing (threshold judgment, ranking, personalized notification, dashboard recording, etc.). As a technical effect, the system can realize high-precision and high-efficiency personalized proposals that respond to diverse customer states, behaviors, and environmental changes, which were difficult with conventional simple history referencing or rule-based processing. This achieves essential improvements in computer technology, such as improved proposal accuracy, customer satisfaction, business efficiency, cross-sell and up-sell rates, and LTV. Application fields include telecommunications, insurance, finance, retail, healthcare, education, tourism, government, B2B sales, e-commerce, ad delivery, and any customer data analysis and proposal operations.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned analysis unit, specifying unit, prioritization unit, and display unit is implemented, for example, in at least one of the smart device 14 and the data processing apparatus 12. For example, the analysis unit is implemented by a specific processing unit 290 of the data processing apparatus 12 and analyzes the customer's past contract history. The specifying unit is implemented, for example, by the specific processing unit 290 of the data processing apparatus 12 and identifies uncontracted products based on the analyzed data. The prioritization unit is implemented, for example, by the specific processing unit 290 of the data processing apparatus 12 and assigns proposal priorities to the identified uncontracted products. The display unit is implemented, for example, by a control unit 46A of the smart device 14 and displays proposal points for the products prioritized. The correspondence between each unit and the apparatus or control unit is not limited to the examples described above and various modifications are possible.

### Second Embodiment

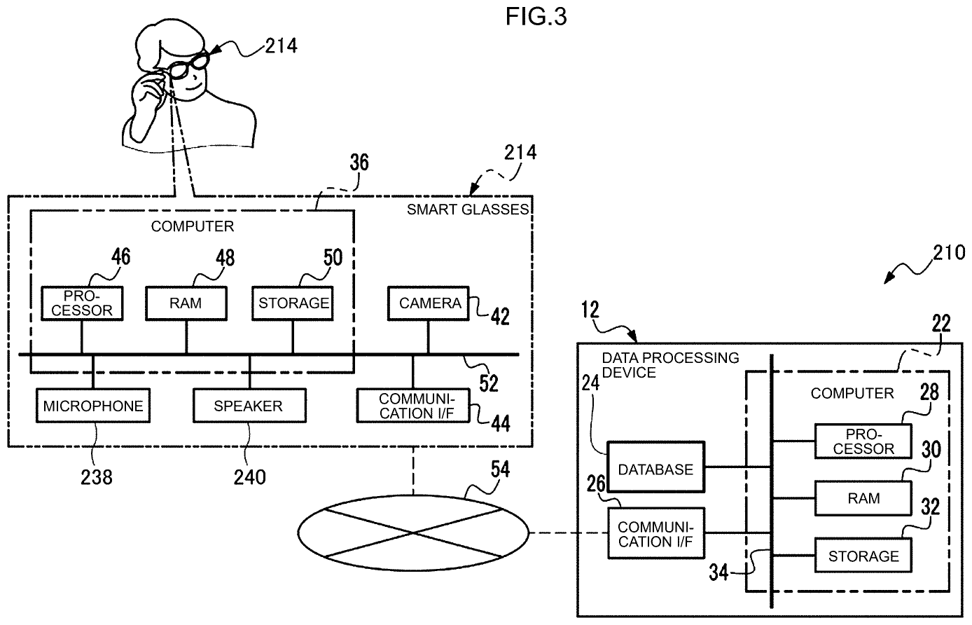

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

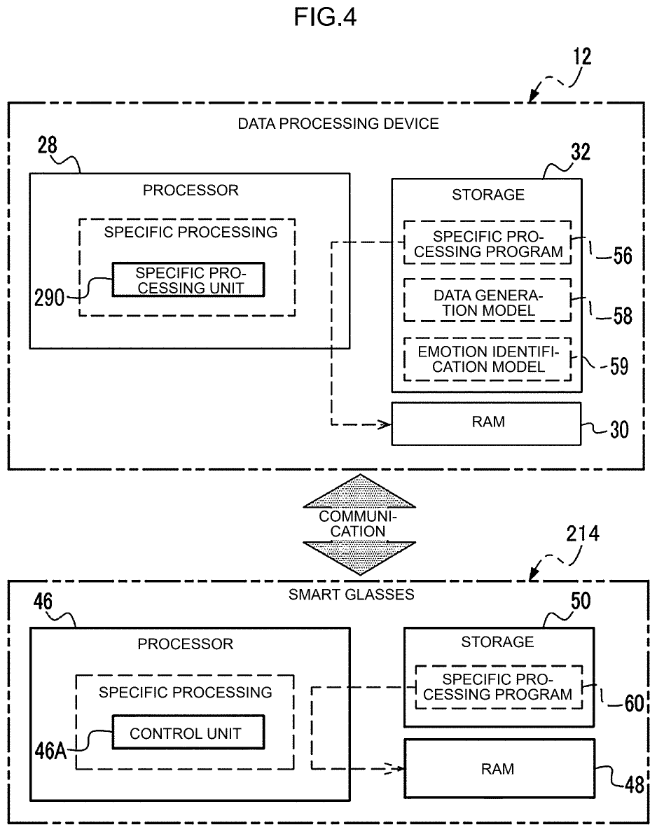

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned analysis unit, specifying unit, prioritization unit, and display unit is implemented, for example, in at least one of the smart glasses 214 and the data processing apparatus 12. For example, the analysis unit is implemented by a specific processing unit 290 of the data processing apparatus 12 and analyzes the customer's past contract history. The specifying unit is implemented, for example, by the specific processing unit 290 of the data processing apparatus 12 and identifies uncontracted products based on the analyzed data. The prioritization unit is implemented, for example, by the specific processing unit 290 of the data processing apparatus 12 and assigns proposal priorities to the identified uncontracted products. The display unit is implemented, for example, by a control unit 46A of the smart glasses 214 and displays proposal points for the products prioritized. The correspondence between each unit and the apparatus or control unit is not limited to the examples described above and various modifications are possible.

### Third Embodiment

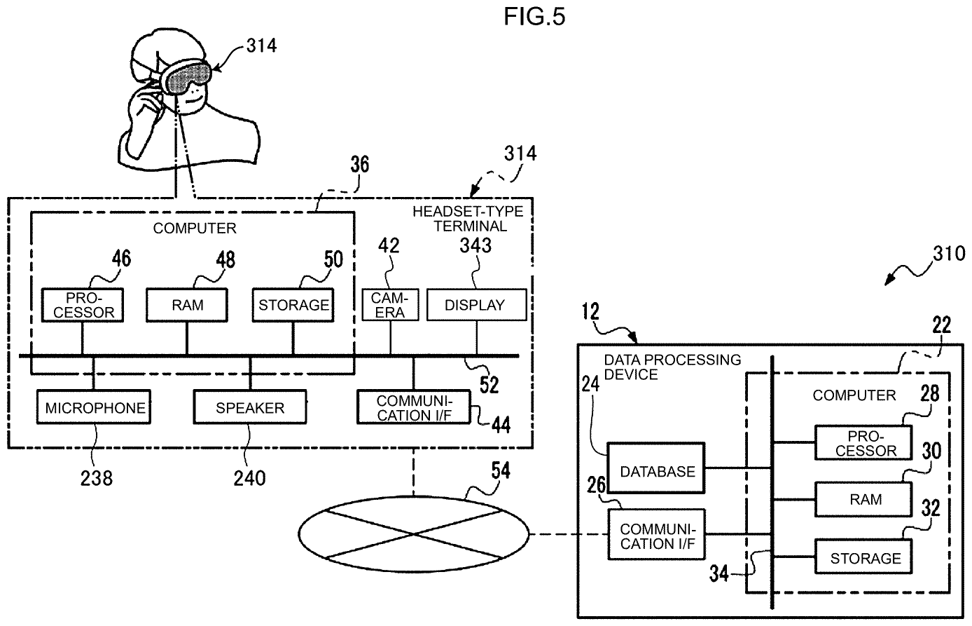

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

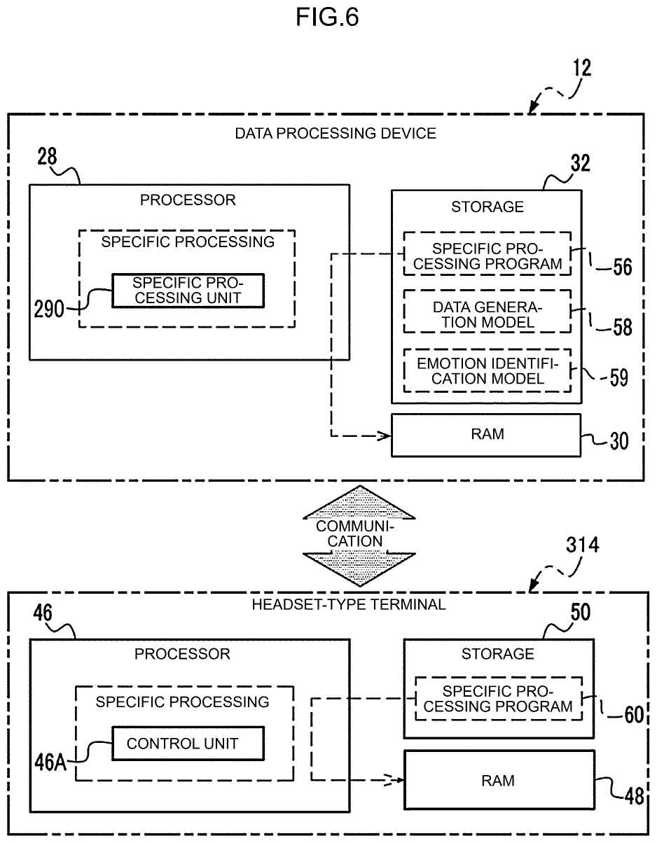

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned analysis unit, specifying unit, prioritization unit, and display unit is implemented, for example, in at least one of the headset-type terminal 314 and the data processing apparatus 12. For example, the analysis unit is implemented by a specific processing unit 290 of the data processing apparatus 12 and analyzes the customer's past contract history. The specifying unit is implemented, for example, by the specific processing unit 290 of the data processing apparatus 12 and identifies uncontracted products based on the analyzed data. The prioritization unit is implemented, for example, by the specific processing unit 290 of the data processing apparatus 12 and assigns proposal priorities to the identified uncontracted products. The display unit is implemented, for example, by a control unit 46A of the headset-type terminal 314 and displays proposal points for the products prioritized. The correspondence between each unit and the apparatus or control unit is not limited to the examples described above and various modifications are possible.

### Fourth Embodiment

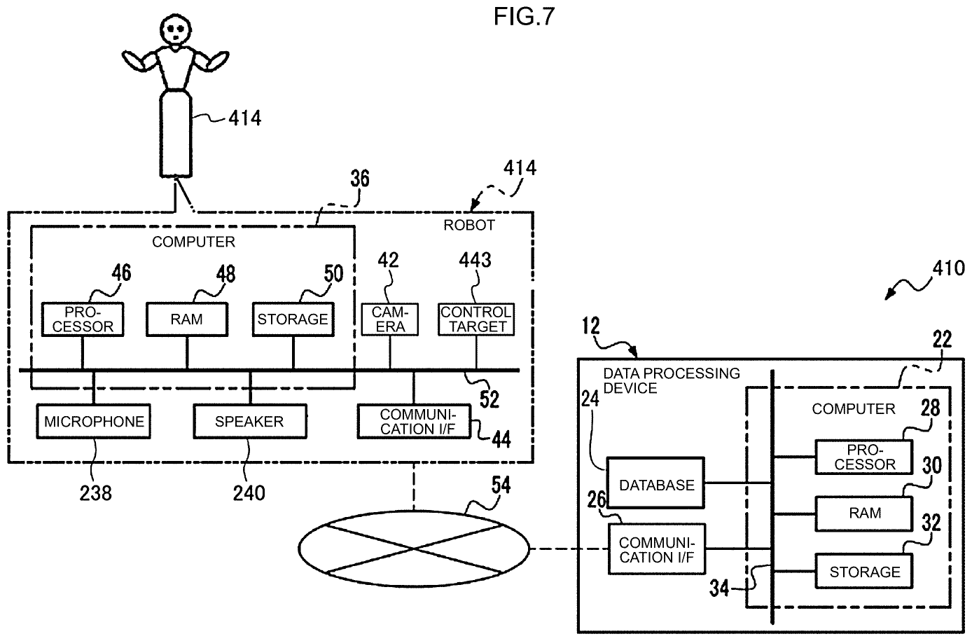

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

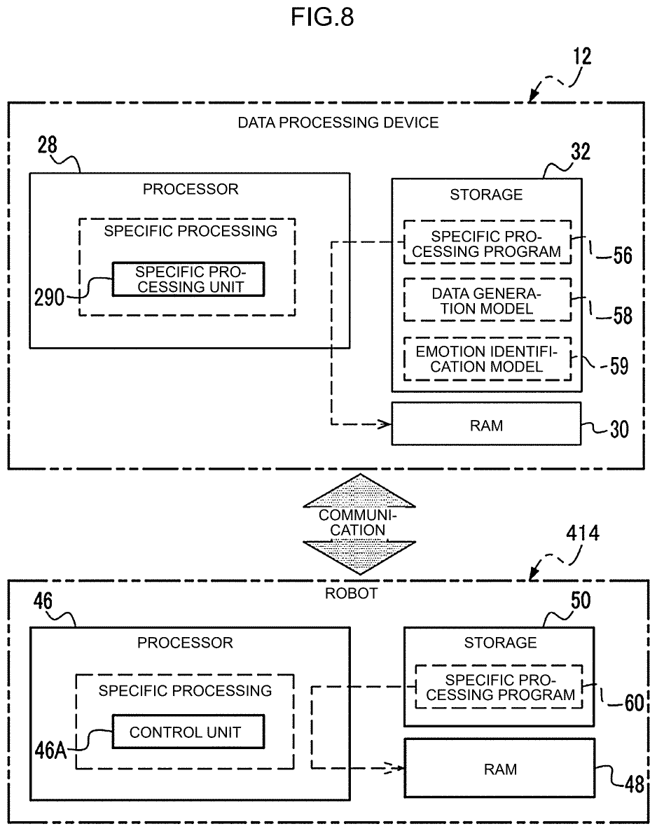

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned analysis unit, specifying unit, prioritization unit, and display unit is implemented, for example, in at least one of the robot 414 and the data processing apparatus 12. For example, the analysis unit is implemented by a specific processing unit 290 of the data processing apparatus 12 and analyzes the customer's past contract history. The specifying unit is implemented, for example, by the specific processing unit 290 of the data processing apparatus 12 and identifies uncontracted products based on the analyzed data. The prioritization unit is implemented, for example, by the specific processing unit 290 of the data processing apparatus 12 and assigns proposal priorities to the identified uncontracted products. The display unit is implemented, for example, by a control unit 46A of the robot 414 and displays proposal points for the products prioritized. The correspondence between each unit and the apparatus or control unit is not limited to the examples described above and various modifications are possible.

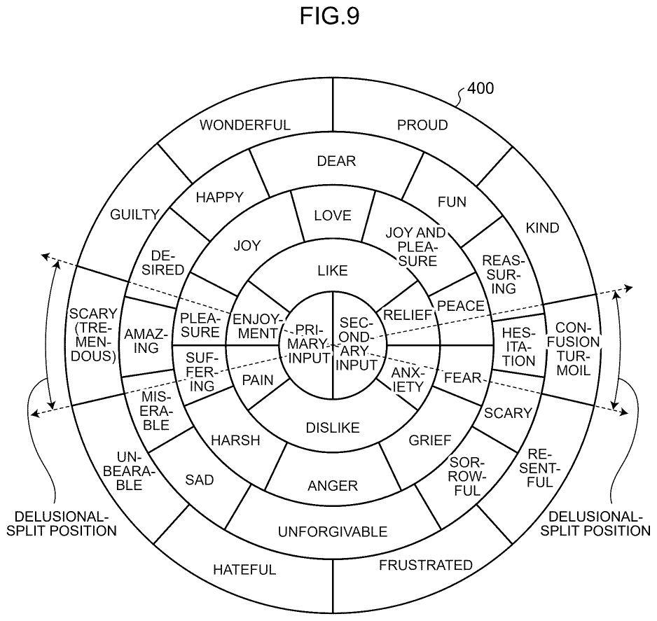

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

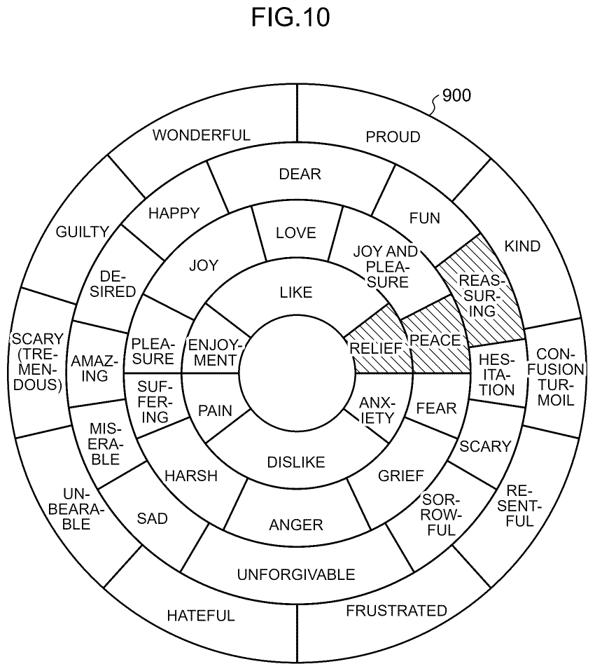

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### Supplementary Note 1

A system comprising: an analysis unit configured to analyze a customer's past contract history; a specifying unit configured to identify uncontracted products based on data analyzed by the analysis unit; a prioritization unit configured to assign proposal priorities to the uncontracted products identified by the specifying unit; and a display unit configured to display proposal points for the products prioritized by the prioritization unit.

### Supplementary Note 2

The system according to Supplementary Note 1, wherein the analysis unit is configured to estimate the customer's emotions and adjust the method of analyzing the contract history based on the estimated emotions of the customer. cl Supplementary Note 3

The system according to Supplementary Note 1, wherein the analysis unit is configured to analyze, in addition to the customer's past contract history, the customer's purchase history or website browsing history.

### Supplementary Note 4

The system according to Supplementary Note 1, wherein the analysis unit is configured to analyze the contract history of the customer based on the frequency of contracts and the contract renewal history when analyzing the contract history.

### Supplementary Note 5

The system according to Supplementary Note 1, wherein the analysis unit is configured to estimate the customer's emotions and adjust the display method of the analysis results based on the estimated emotions of the customer.

### Supplementary Note 6

The system according to Supplementary Note 1, wherein the analysis unit is configured to analyze the contract history of the customer by taking into account the customer's geographic location information when analyzing the contract history.

### Supplementary Note 7

The system according to Supplementary Note 1, wherein the analysis unit is configured to analyze the customer's contract history by analyzing the customer's social media activities and obtaining relevant information.

### Supplementary Note 8

The system according to Supplementary Note 1, wherein the specifying unit is configured to estimate the customer's emotions and adjust the method of identifying uncontracted products based on the estimated emotions of the customer.

### Supplementary Note 9

The system according to Supplementary Note 1, wherein the specifying unit is configured to take into account, in addition to the customer's past contract history, the customer's purchase history and website browsing history when identifying uncontracted products.

### Supplementary Note 10

The system according to Supplementary Note 1, wherein the specifying unit is configured to identify uncontracted products based on the popularity of the products or market trends when identifying uncontracted products.

### Supplementary Note 11

The system according to Supplementary Note 1, wherein the specifying unit is configured to estimate the customer's emotions and adjust the display method of the identified uncontracted products based on the estimated emotions of the customer.

### Supplementary Note 12

The system according to Supplementary Note 1, wherein the specifying unit is configured to identify uncontracted products by taking into account the customer's geographic location information when identifying uncontracted products.

### Supplementary Note 13

The system according to Supplementary Note 1, wherein the specifying unit is configured to analyze the customer's social media activities and identify relevant products when identifying uncontracted products.

### Supplementary Note 14

The system according to Supplementary Note 1, wherein the prioritization unit is configured to estimate the customer's emotions and adjust the proposal priorities based on the estimated emotions of the customer.

### Supplementary Note 15

The system according to Supplementary Note 1, wherein the prioritization unit is configured to take into account, in addition to the customer's past contract history, the customer's purchase history and website browsing history when assigning proposal priorities.

### Supplementary Note 16

The system according to Supplementary Note 1, wherein the prioritization unit is configured to take into account the popularity of the products and market trends when assigning proposal priorities.

### Supplementary Note 17

The system according to Supplementary Note 1, wherein the prioritization unit is configured to estimate the customer's emotions and adjust the display method of the prioritization results based on the estimated emotions of the customer.

### Supplementary Note 18

The system according to Supplementary Note 1, wherein the prioritization unit is configured to determine proposal priorities by taking into account the customer's geographic location information when assigning proposal priorities.

### Supplementary Note 19

The system according to Supplementary Note 1, wherein the prioritization unit is configured to analyze the customer's social media activities and take into account relevant information when assigning proposal priorities.

### Supplementary Note 20

The system according to Supplementary Note 1, wherein the display unit is configured to estimate the customer's emotions and adjust the display method of the proposal points based on the estimated emotions of the customer.

### Supplementary Note 21

The system according to Supplementary Note 1, wherein the display unit is configured to display, in addition to the proposal points, the customer's past contract history, purchase history, and website browsing history when displaying proposal points.

### Supplementary Note 22

The system according to Supplementary Note 1, wherein the display unit is configured to display the popularity of the products and market trends when displaying proposal points.

### Supplementary Note 23

The system according to Supplementary Note 1, wherein the display unit is configured to estimate the customer's emotions and adjust the priorities of the display contents based on the estimated emotions of the customer.

### Supplementary Note 24

The system according to Supplementary Note 1, wherein the display unit is configured to display proposal points by taking into account the customer's geographic location information when displaying proposal points.

### Supplementary Note 25

The system according to Supplementary Note 1, wherein the display unit is configured to analyze the customer's social media activities and display relevant information when displaying proposal points.

What is claimed is:

1. A system comprising:
circuitry configured to:
receive, via a communication interface coupled to a packet-switched network, a query signal and structured data records from a client terminal;
generate a multidimensional tensor from the structured data records, each structured data record encoded as a feature vector;
apply a Transformer-based neural network comprising a self-attention mechanism to the multidimensional tensor to extract relational feature representations among the structured data records in a high-dimensional vector space;
compute, by the Transformer-based neural network, a set of relevance scores by comparing the relational feature representations against reference data stored in a database, each relevance score being a continuous numerical value;
generate classification output data by applying a threshold filter to the set of relevance scores and ranking entries of the reference data according to the relevance scores; and
generate inference data comprising natural language text for each entry in the classification output data by inputting the classification output data into a language generation model, and transmit the inference data to the client terminal via the communication interface over the packet-switched network.

2. The system according to claim 1, wherein the structured data records comprise transaction history data of an entity, the transaction history data comprising at least one of a transaction identifier, a start date, an end date, a monetary value, or a cancellation status.

3. The system according to claim 1, wherein the circuitry is further configured to estimate an emotion of a user associated with the query signal by applying an emotion identification model to at least one of voice data, text data, or image data received from the client terminal, and to adjust an analysis method applied to the structured data records based on the estimated emotion.

4. The system according to claim 3, wherein when the estimated emotion indicates stress, the circuitry applies a simplified analysis using a subset of features of the structured data records, and when the estimated emotion indicates relaxation, the circuitry applies a detailed analysis using all features of the structured data records.

5. The system according to claim 1, wherein the circuitry is further configured to receive, from the client terminal via the communication interface, supplemental data records comprising at least one of purchase history data or browsing history data, vectorize the supplemental data records as a time-series tensor, and apply a time-series recurrent neural network to the time-series tensor to extract behavioral feature vectors for use in computing the set of relevance scores.

6. The system according to claim 1, wherein the circuitry is further configured to analyze a frequency attribute and a renewal attribute of the structured data records using a time-series recurrent neural network or the Transformer-based neural network to generate a continuation tendency score and a renewal probability for each structured data record.

7. The system according to claim 1, wherein the circuitry is further configured to estimate an emotion of a user by applying an emotion identification model comprising a multimodal neural network to at least one of voice data, text data, or facial image data received from the client terminal, the emotion identification model outputting a probability distribution across a plurality of emotion categories.

8. The system according to claim 7, wherein the circuitry is further configured to adjust a display format of the inference data based on the estimated emotion, such that when the estimated emotion indicates stress, the circuitry generates the inference data in a simplified text format, and when the estimated emotion indicates excitement, the circuitry generates the inference data in a format comprising graphical visualization data.

9. The system according to claim 1, wherein the circuitry is further configured to receive geographic location data from the client terminal via the communication interface, encode the geographic location data as a categorical vector, and input the categorical vector together with the multidimensional tensor into the Transformer-based neural network to generate region-specific relational feature representations.

10. The system according to claim 1, wherein the circuitry is further configured to acquire social media activity data associated with the entity identifier via the communication interface, apply a text analysis model to the social media activity data to extract supplemental feature vectors, and combine the supplemental feature vectors with the relational feature representations for use in computing the set of relevance scores.

11. The system according to claim 1, wherein the circuitry is further configured to collect, via the communication interface, trend data comprising at least one of search volume data, social media post frequency data, or seasonality index data, generate a trend feature vector for each entry of the reference data based on the trend data, and incorporate the trend feature vector into the computation of the set of relevance scores.

12. The system according to claim 1, wherein the circuitry is further configured to estimate an emotion of a user and to adjust a ranking criterion applied to the classification output data based on the estimated emotion, such that when the estimated emotion indicates stress, the circuitry applies a ranking criterion that prioritizes entries associated with a high urgency attribute.

13. The system according to claim 1, wherein the feature vector comprises at least ten dimensions representing attributes of the structured data records, the attributes comprising at least one of a category identifier, a temporal duration, a monetary value, a usage frequency, or a status indicator.

14. The system according to claim 1, wherein the threshold filter comprises a configurable threshold value, and wherein the circuitry is configured to transmit only entries of the reference data having relevance scores exceeding the configurable threshold value to the language generation model for generation of the inference data.

15. The system according to claim 1, wherein the language generation model comprises a large language model, and wherein the circuitry is configured to generate the inference data by constructing a prompt comprising the classification output data and context data derived from the relational feature representations, and inputting the prompt into the large language model.

16. The system according to claim 1, wherein the circuitry is further configured to estimate an emotion of a user and to adjust a priority of content within the inference data based on the estimated emotion, such that when the estimated emotion indicates stress, the circuitry prioritizes inference data associated with a high relevance score.

17. The system according to claim 1, wherein the circuitry is further configured to store the inference data in the database together with a timestamp, and to analyze past inference data stored in the database to select a format of subsequent inference data based on content trends derived from the past inference data.

18. A system comprising:
circuitry configured to:
receive, via a communication interface coupled to a packet-switched network, a query signal comprising an entity identifier and structured data records from a client terminal, each structured data record comprising a transaction identifier, a start date, an end date, a monetary value, and a status indicator;
generate a multidimensional tensor from the structured data records by encoding each structured data record as a feature vector having at least ten dimensions;
apply a Transformer-based neural network comprising a multi-head self-attention mechanism to the multidimensional tensor to extract relational feature representations among the structured data records in a high-dimensional vector space;
estimate an emotion of a user by applying an emotion identification model comprising a multimodal neural network to at least one of voice data, text data, or facial image data received from the client terminal, the emotion identification model outputting a probability distribution across a plurality of emotion categories;
compute, by the Transformer-based neural network, a set of relevance scores by comparing the relational feature representations against reference data stored in a database, each relevance score being a continuous numerical value between 0.0 and 1.0;
generate classification output data by applying a threshold filter to the set of relevance scores and ranking entries of the reference data according to the relevance scores;
generate inference data comprising natural language text for each entry in the classification output data by inputting the classification output data into a language generation model comprising a large language model; and
adjust at least one of a format, a level of detail, or a priority of the inference data based on the estimated emotion, and transmit the inference data to the client terminal via the communication interface over the packet-switched network.

19. The system according to claim 18, wherein the language generation model is a fine-tuned model configured to output inference results from prompts without instructions, and wherein the circuitry is configured to generate the inference data by constructing a prompt comprising the classification output data and context data derived from the relational feature representations.

20. A method performed by circuitry of a system, the method comprising:
receiving, via a communication interface coupled to a packet-switched network, a query signal and structured data records from a client terminal;
generating a multidimensional tensor from the structured data records, each structured data record encoded as a feature vector;
applying a Transformer-based neural network comprising a self-attention mechanism to the multidimensional tensor to extract relational feature representations among the structured data records in a high-dimensional vector space;
computing, by the Transformer-based neural network, a set of relevance scores by comparing the relational feature representations against reference data stored in a database, each relevance score being a continuous numerical value;
generating classification output data by applying a threshold filter to the set of relevance scores and ranking entries of the reference data according to the relevance scores; and
generating inference data comprising natural language text for each entry in the classification output data by inputting the classification output data into a language generation model, and transmitting the inference data to the client terminal via the communication interface over the packet-switched network.
